(19) United States
(12) Patent Application Publication
(10) Pub. No.: US 2021/0174013 A1
(43) Pub. Date: Jun. 10, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yushi HARADA, Kanagawa (JP)

(73) Assignee: FUJI XEROX CO., LTD., Tokyo (JP)

(21) Appl. No.: 16/854,859

(22) Filed: Apr. 21, 2020

(30) Foreign Application Priority Data
Dec. 5, 2019 (JP) 2019-220559

(51) Int. Cl. G06F 40/197; G06F 40/194; G06F 40/123; G06F 40/166; G06F 40/106; G06N 20/00; G06N 5/04

(52) U.S. Cl. CPC G06F 40/197; G06F 40/194; G06F 40/123; G06N 5/04; G06F 40/106; G06N 20/00; G06F 40/166

(57) ABSTRACT

An information processing apparatus includes a processor configured to perform difference extraction processing of extracting a difference between two versions of each of a first document element and a second document element, and perform determination processing of determining a relation between the first document element and the second document element based on a similarity between the difference for the first document element and the difference for the second document element.

### CROSS-REFERENCE TO RELATED APPLICATIONS

This application is based on and claims priority under 35 USC 119 from Japanese Patent Application No. 2019-220559 filed Dec. 5, 2019.

### BACKGROUND

### (i) Technical Field

The present invention relates to an information processing apparatus and a non-transitory computer readable medium storing a program.

### (ii) Related Art

The world is full of interrelated documents. In a case where one of the interrelated documents is changed, some of the remaining documents may be required to be changed accordingly. There is a mechanism in which, in a case where a certain document is changed, a participant (for example, author) of a document related to the changed document is informed of the change, and thereby being urged to perform a required countermeasure such as a change of a document.

For example, JP2000-155731A discloses a document update notification device as follows. That is, the device determines whether or not document data of a homepage has been changed. In a case where the document data has been changed, the device automatically adds information indicating that change has been performed, onto a document related to the changed document. Thus, the device notifies a user allowed to access the document of the change via a communication line.

JP1999-306055A discloses a system that includes a unit that records the latest status of a document recorded in a different medium, in a computer, a unit that defines creation, revision, and deletion of a document, and an influence relation between documents, a unit that restricts use such that only the latest document can be used, a unit that extracts a document having an influence relation with a certain document when the document is revised or deleted, and notifies a person having an authority to revise or delete the document that a check of necessity for revision or deletion, and a unit that recognizes a document in which check of whether or not the document is influenced by creation, revision, or deletion of another document is completed.

An apparatus that determines a relation between documents from similarity between the contents of the documents is also known.

### SUMMARY

In some cases, appropriate determination of a relation between two document elements from similarity between all document elements is not possible. For example, similarity between a provision in a law and a company rule article for the provision may not be high in terms of all provisions and all company rule articles, but, actually, both have a strong relation.

Aspects of non-limiting embodiments of the present disclosure relate to an information processing apparatus and a non-transitory computer readable medium storing a program, that is capable of obtaining a relation between document elements, which is not understood by determination based only on similarity between all document elements.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to perform difference extraction processing of extracting a difference between two versions of each of a first document element and a second document element, and perform determination processing of determining a relation between the first document element and the second document element based on a similarity between the difference for the first document element and the difference for the second document element.

### BRIEF DESCRIPTION OF THE DRAWINGS

Exemplary Embodiment(s) of the Present Invention Will be Described in Detail Based on the Following Figures, Wherein:

FIG. 1 is a diagram illustrating a configuration of an entire system including a document service system;

FIG. 2 is a diagram illustrating an example of a document creation operation in the system in FIG. 1;

FIG. 3 is a diagram illustrating a hardware configuration of a computer on which the document service system is mounted;

FIG. 4 is a diagram illustrating an example of a database construction and maintenance processing procedure performed by the document service system;

FIG. 5 is a diagram illustrating a structure of a document;

FIG. 6 is a diagram illustrating a data structure of a document property in a database;

FIG. 7 is a diagram illustrating a data structure of an element property in the database;

FIG. 8 is a diagram illustrating relation information in the database;

FIG. 9 is a diagram illustrating an example of an information providing screen provided by the document service system;

FIG. 10 is a diagram illustrating a processing procedure for generating the information providing screen, which is performed by the document service system;

FIG. 11 is a diagram illustrating another example of the information providing screen provided by the document service system;

FIG. 12 is a diagram illustrating another example of the processing procedure for generating the information providing screen, which is performed by the document service system;

FIG. 13 is a diagram illustrating still another example of the information providing screen provided by the document service system;

FIG. 14 is a diagram illustrating still another example of the processing procedure for generating the information providing screen, which is performed by the document service system;

FIG. 15 is a diagram illustrating an example of a graph display provided by the document service system;

FIG. 16 is a diagram illustrating a part of a procedure of notification processing performed by the document service system;

FIG. 17 is a diagram illustrating a procedure of causing an AI that determines the type of relation between document elements, to perform learning;

FIG. 18 is a diagram illustrating an example of a difference between two versions of two document elements;

FIG. 19 is a diagram illustrating an example of a procedure of determining the type of relation between document elements;

FIG. 20 is a diagram illustrating another example of the difference between the two versions of the two document elements;

FIG. 21 is a diagram illustrating still another example of the difference between the two versions of the two document elements;

FIG. 22 is a diagram illustrating still yet another example of the difference between the two versions of the two document elements;

FIG. 23 is a diagram illustrating another example of the procedure for determining the type of the relation between the document elements; and

FIG. 24 is a diagram illustrating still another example of the procedure for determining the type of relation between the document elements.

### DETAILED DESCRIPTION

Example of Entire System

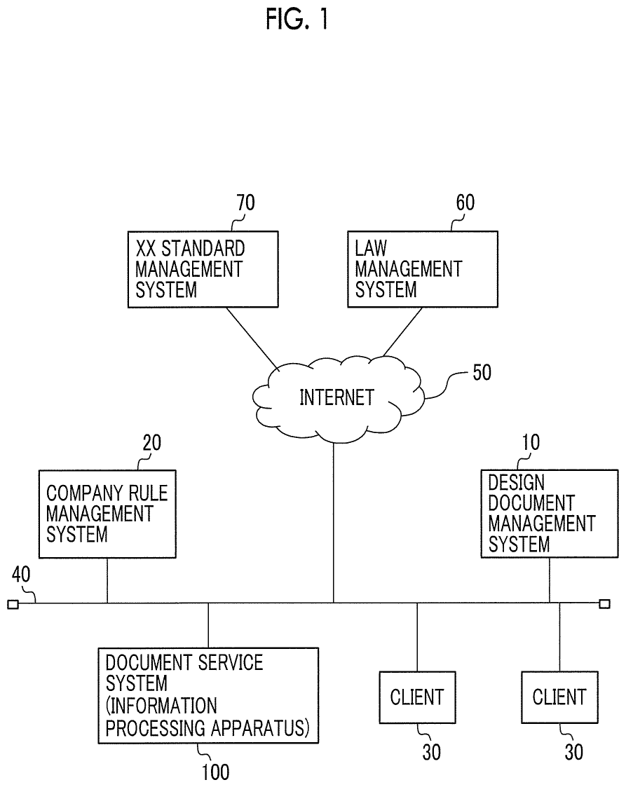

FIG. 1 illustrates an entire system for using a document, which includes a document service system 100 being an exemplary embodiment of an information processing apparatus according to an exemplary embodiment of the present invention.

In the example, a document service system 100 is connected to an internal network 40 in a certain company. One or more document management systems for managing various internal documents, such as a design document management system 10 or a company rule management system 20, are connected to the internal network 40. A client 30 such as a personal computer operated by a user is connected to the internal network 40.

Various document management systems such as a law management system 60 and an XX standard management system 70 that manages standard documents of an “XX” technology are provided on the Internet 50. Apparatuses such as the document service system 100 and a client 30 on the internal network 40 are capable of accessing documents of the document management system on the Internet 50.

In a case where one document related to another document in an internal document management system such as the design document management system 10 is changed, the document service system 100 provides a service (for example, notifying a concerned person of the change) corresponding to the change of the one document for the another document.

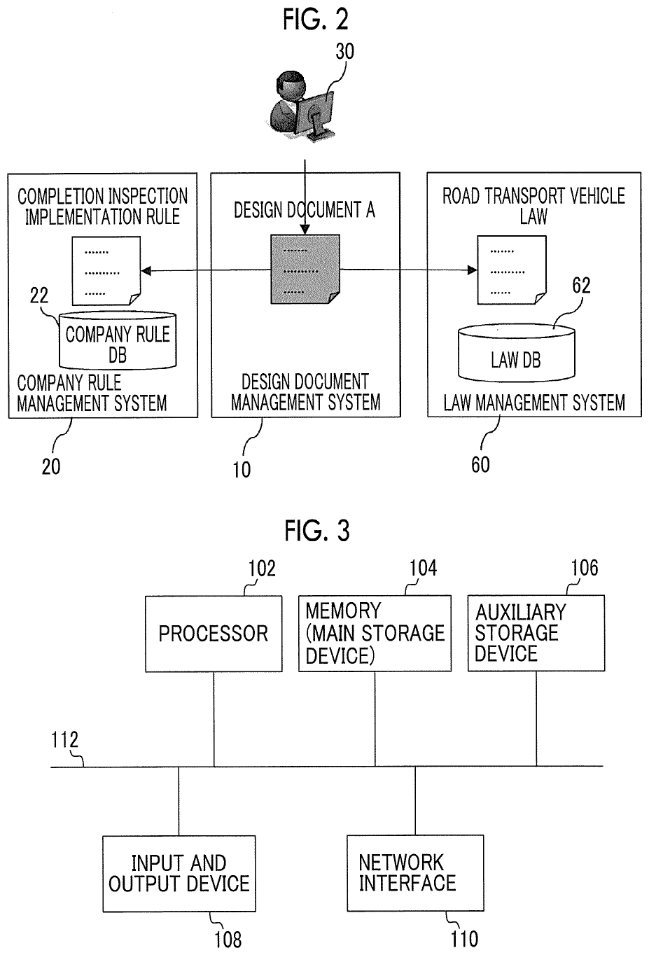

As illustrated in FIG. 2, a case where a user in a company creates a design document A of a product, registers the created document in the design document management system 10, and maintains the registered document is considered. Since the product is required to be designed to satisfy various laws and various company rules, the design document A is also created with reference to other documents such as the laws and the company rules. For example, the design document A is created with reference to the Road Transport Vehicle Law registered in a law DB 62 of the law management system 60 and a completion inspection implementation rule registered in a company rule DB 22 of the company rule management system 20. The law in the law DB 62 and the rule in the company rule DB 22 are updated at any time in accordance with the revision.

In a case where the Road Transport Vehicle Law and the completion inspection implementation rule are revised, the content of the design document A may be required to be updated, but the update is not always necessary. For example, in a case where the revised part of the law or the like is different from the part on which the content of the design document A depends, the content of the design document A is not required to be updated.

In addition, even though the design document A is created based on a certain part of the law, various methods of depending on the part are provided. For example, there is a case where a section of the law is cited in the design document A by copying the section itself, and there is a case where coincidence of terms between the relevant part of the law and a part of the design document A can be found just by describing the part of the design document A while checking the relevant part of the law. In the former case, necessity to revise the cited part in the design document A by the section of the law being revised is high. On the contrary, in the latter case, the degree of necessity for a response of the design document A to the revision of the relevant part of the law is lower than the degree of necessity in the former case.

Thus, in the exemplary embodiment, the document service system 100 provides a participant of a document such as a person in charge of managing the design document A with, for example, a service of supporting an operation of determining whether or not the document is required to be changed in response to a change of another document related to the above document.

Here, the “document” refers to data in any data format, and the data format is not particularly limited. For example, the document may refer to data in a text data format or in various document file formats such as a PDF format. The document may refer to image data in various image data formats or a moving image data. The document may refer to data in a structured document format such as a Hypertext Markup Language (HTML) format or an Extensible Markup Language (XML) format.

In this specification, “a participant” for a document refers to an individual or a user group involved in maintaining the content of the document. The participant may be, for example, a person in charge of maintenance of the content of the document, or may have a role of urging the person in charge to perform the maintenance. For example, a user who has created the document or a user who has updated the document is a representative example of the participant. A document may be configured with a plurality of document elements, and a participant may be set for each document element.

Example of Hardware Configuration

The document service system 100 is implemented by causing a computer to execute a program representing a function of the system.

Here, for example, as illustrated in FIG. 3, a computer serving as a base of the document service system 100 has a circuit configuration as follows, as hardware. In the circuit configuration, a processor 102, a memory (main storage device) 104 such as a random access memory (RAM), a controller for controlling an auxiliary storage device 106 such as a flash memory, a solid state drive (SSD), and a hard disk drive (HDD), an interface with various input and output devices 108, and a network interface 110 for controlling a connection with a network such as a local area network are connected to each other via a data transmission path such as a bus 112, for example. A program in which the processing content of each function of the document service system 100 is described is installed on the computer via the network or the like, and is stored in the auxiliary storage device 106. Functions of the document service system 100 are realized by the processor 102 executing the program stored in the auxiliary storage device 106 using the memory 104.

In the embodiments above, the term “processor” 102 refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” 102 is broad enough to encompass one processor 102 or plural processors 102 in collaboration which are located physically apart from each other but may work cooperatively. The order of operations of the processor 102 is not limited to one described in the embodiments above, and may be changed.

Other apparatuses such as the design document management system 10, the company rule management system 20, and the client 30 are also configured using a computer as a base, similar to the document service system 100.

Database Construction

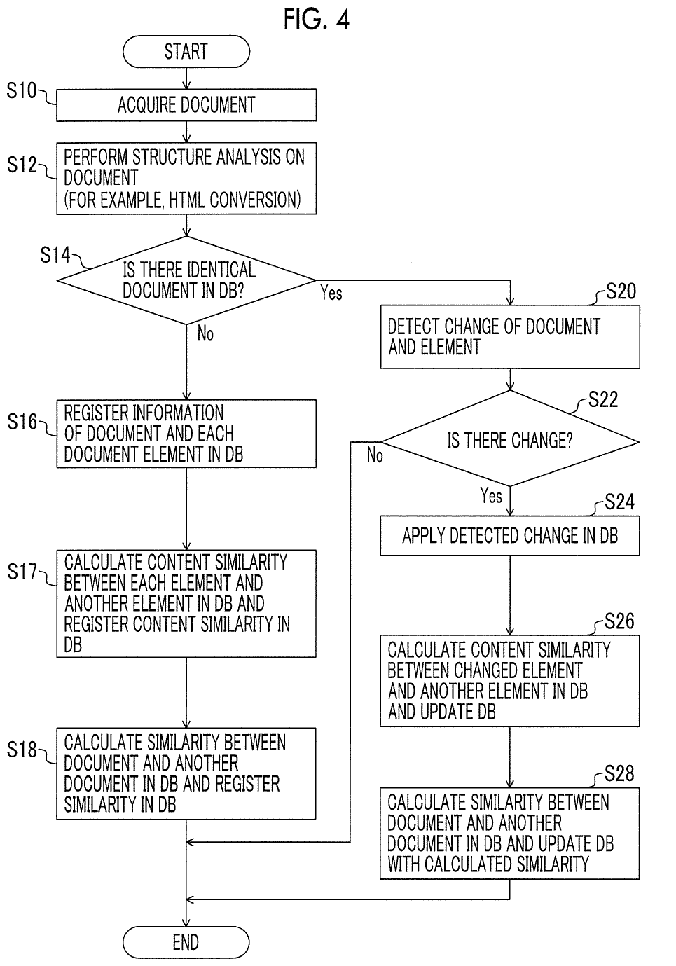

An example of database construction processing used for the document service system 100 providing a service will be described with reference to FIGS. 4 to 8. The database is constructed in the auxiliary storage device 106 in the document service system 100.

For example, the document service system 100 periodically visits predetermined document management systems inside and outside a company, such as the design document management system 10, the company rule management system 20, and the law management system 60, so as to acquire and analyze a document group registered in the document management systems. In this case, the document service system 100 analyzes information of which a notification is made. A procedure illustrated in FIG. 4 shows a process performed when the document service system 100 acquires one document from any document management system (S10).

In this case, the processor 102 in the document service system 100 analyzes the structure of the acquired document to divide the document into document element units (S12). The structure analysis is performed, for example, by processing of converting a document into a HyperText Markup Language (HTML) format. Various tools for HTML conversion are provided. In S12, a tool appropriate for the file format of the document may be used. Alternatively, the structure analysis may be performed using a known technology of recognizing the structure of a heading, a chapter, a section, a paragraph, or the like from the document content. In a case where the acquired document is already a structured document in the XML format or the like, the process of S12 may be omitted.

Then, the processor 102 determines whether or not data of a document identical to the document acquired in S10 is registered in a database (S14). Here, “identical” does not mean that the entire contents of the documents are identical to each other, but that the documents have the identical identification information. The identification information of a document is referred to as a document ID. In S14, whether or not information on a document having a document ID identical to a document ID of the acquired document is in the database is determined.

As the document ID, for example, a combination of identification information of the document management system (for example, company rule management system 20 or law management system 60) as an acquisition source of the document and identification information of the document in the document management system may be used. For example, a uniform resource locator (URL) of the document in the document management system may be used as the document ID of the document.

In a case where the determination result in S14 is No, the document acquired in S10 is a document that the processor 102 firstly encounters. In this case, the processor 102 registers information on the document acquired in S10 and information on each document element obtained by the structure analysis in S12, in the database (S16).

The processor 102 calculates the similarity of the content of each document element with contents of other document elements registered in the database, and registers the obtained similarity in the database for each document element (S17). The similarity of the content between the document elements may be obtained, for example, in a manner that a text string included in the document element is vectorized, and the similarity between the obtained vectors of the document elements is calculated by a known method (for example, cosine similarity). As a method of vectorizing the text string of the document element, a known method such as term frequency-inverse document frequency (TF-IDF) or doc2vec may be used.

Here, “the other document element” being a partner for obtaining the similarity with the document element obtained in S12 is typically a document element of another document registered in the database. However, the present invention is not limited to the above method, and the similarity between the document elements obtained in S12 may be further calculated.

The processor 102 calculates the similarity between the document acquired in S10 and another document registered in the database, and registers the similarity of the calculation result in the database (S18). For example, text strings obtained in a manner that text strings of headings of a chapter and a section in the document obtained by the structure analysis in S12 are arranged and merged in order of appearing are set as text strings indicating characteristics of the document, and the text strings are vectorized. The similarity between the vectors of the text strings indicating the characteristics of the documents obtained in this manner is obtained as the similarity between the documents. A method of calculating the similarity between documents is not limited to this. In addition, for example, a tree structure configured with document elements (for example, chapters, sections, and paragraphs) in a document may be set as characteristics of the document, and the similarity between the characteristics may be set as the similarity between documents.

In a case where the determination result in S14 is Yes, data of the document acquired in S10 is registered in the database of the document service system 100. In this case, the processor 102 examines whether or not the document acquired in S10 and each document element obtained in S12 have been changed from the document and document element registered in the database (S20). In this step, for example, for each document element obtained in S12, the processor compares the content of the document element (that is, text string) with the content of the identical document element (that is, document element having the identical identification information) in the database. Ina case where both the contents coincide with each other, the processor determines that the document elements are not changed. In a case where both the contents do not coincide with each other, the processor determines that the document elements are changed. A case where the document element identical to the document element obtained in S12 is not in the database or a case where a document element identical to a document element in the database is not provided in the structure analysis result in S12 corresponds to an example of a case where the document element is changed. A case where any one or more document elements are determined to be changed refers to a case where the entire document is changed. A case where there is no document element determined to be changed refers to a case where the entire document is not changed.

The processor 102 determines whether or not the change in the document or the document element has been detected in S20 (S22). In a case where the change has been detected, the processor 102 applies information on the detected change in the database (S24). For example, in a case where the content of a certain document element has been changed, the content of the document element in the database is updated to the content after the change. For a document element of which no change has been detected, the information registered in the database is not required to be changed. In a case where the change of the document element in the document is detected, information such as the update date and time of the document in the database is changed.

The processor 102 calculates the similarity of the content between the document element of which the change of the content has been detected in S20, and another document element in the database. The processor updates the value of the similarity between the document elements, which has been registered in the database, to a value obtained by the calculation (S26). In a case where the document element of which the change of the content has been detected in S20 is a new document element which is not in the database, the processor calculates the similarity between the new document element and another document element in the database, and registers the similarity in the database. In a case where deletion of the document element which has been in the database is detected in S20, information on the similarity between the deleted document element and another document element may be deleted from the database. The process of S26 is not performed on the document element of which the change has not been detected.

The processor 102 calculates the similarity between the document acquired in S10 and another document in the database in a manner similar to that in S18. Then, the processor updates the similarity between this document and another document in the database, in accordance with the calculation result (S28).

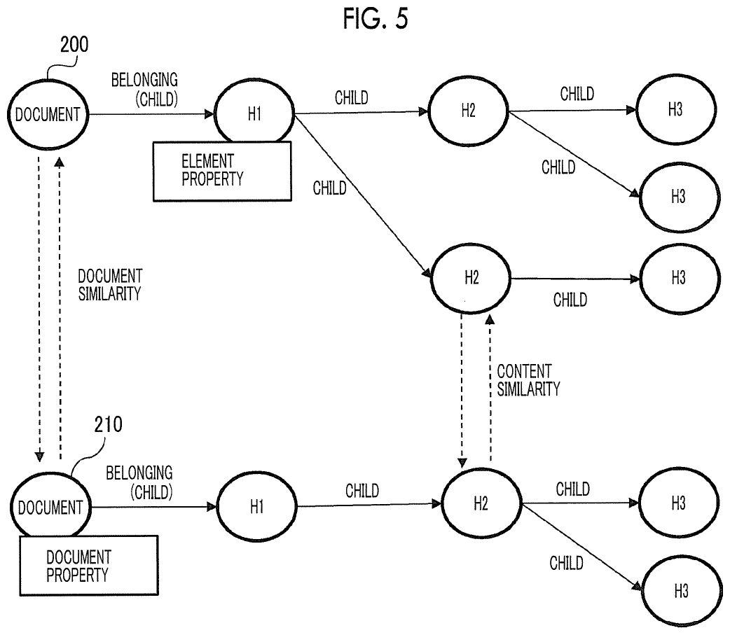

An example of information registered in the database in the document service system 100 will be described with reference to FIGS. 5 to 8.

FIG. 5 illustrates information on a structure analysis result of two documents 200 and 210 registered in the database by HTML. The document 200 has an H1 element (for example, title of the document) as a child document element (referred to as a child element below), and the H1 element has two H2 elements as child elements. The H2 elements have two H3 elements and one H3 element, as a child element, respectively. As described above, structure information on the document 200 is represented by a tree structure illustrated in FIG. 5. Unique identification information is assigned to the document and each document element. Data representing the tree structure illustrated in FIG. 5 is registered, as the structure information on the document, in the database in association with the identification information of the document.

Property data (referred to as “document property”) for each of the documents 200 and 210 and property data (referred to as “element property”) for each document element are registered in the database.

The similarity between the document 200 and the document 210 is calculated and registered in the database. The similarity of the content between the document elements is calculated and registered in the database.

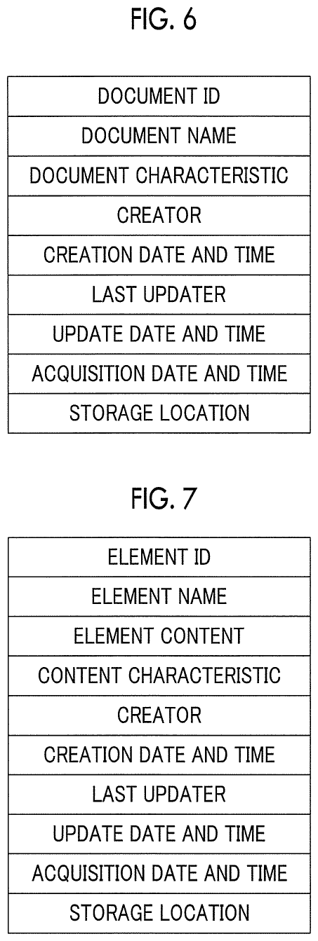

FIG. 6 illustrates an example of a data structure of the document property registered in the database. The document property of the document illustrated in FIG. 6 includes items such as a document ID, a document name, a document characteristic, a creator, the creation date and time, the last updater, the update date and time, the acquisition date and time, and a storage location of the document. The document name is, for example, a file name of the document. The document characteristic refers to data indicating the characteristics of the document. For example, as described above, a text string obtained by arranging and merging text strings of headings of a chapter and a section in the document in order of appearing is provided as an example of the document characteristic. The resultant obtained by vectorizing the text string may be used as the document characteristic. The creator indicates the user ID of a user who has firstly created the document, and the creation date and time indicate the date and time of creation. The last updater indicates the user ID of a user who has updated the document last, and the update date and time indicate the date and time of the update. The types of information on the creator, the creation date and time, the last updater, and the update date and time may be acquired from attribute data of the file of the document, for example. The acquisition date and time indicate the date and time on which the processor 102 has acquired the document last from the document management system such as the company rule management system 20 or the law management system 60. The storage location refers to information of specifying the document management system in which the document has been originally stored (for example, URL of the document management system).

In S18 and S26 in the procedure of FIG. 4 described above, such information on the document property and information on the tree structure of the document obtained in S12 are registered in the database.

FIG. 7 illustrates an example of a data structure of the element property registered in the database. The element property of the document element illustrated in FIG. 7 include items such as an element ID, an element name, an element content, a content characteristic, a creator, the creation date and time, the last updater, the update date and time, the acquisition date and time, and a storage location of the document element. The element ID refers to identification information of the document element. For example, a set of a document ID of a document including the document element and a number uniquely assigned to the document element in the document may be used as the element ID. The element name refers to the name of the document element. For example, in a case where the document element includes a heading, the heading may be used as the element name. In a case where the document element does not include the heading, a text string having a predetermined number of characters at the head of the document element may be used as the element name. The element content refers to data of the content of the document element. For example, in a case where the document element is a text, the element content is a text string of the text. The element characteristic refers to data indicating the characteristic of the document element, and is obtained by vectorizing the text string of the document element described above, for example. The creator indicates the user ID of a user who has firstly created the document, and the creation date and time indicate the date and time of creation. In a case where the original document file (or the document management system that manages the original document file) has information on the creator or the creation date and time for each document element, the information is registered in the item of the creator or the creation date and time in the element property. In a normal case where the file of the original document has only the creator and the creation date and time in a document unit, the creator and the creation date and time of the document are registered in the creator and the creation date and time of the document element included in the document in the element property.

The last updater indicates the user ID of a user who has updated the document element last, and the update date and time indicate the date and time of the update. In a case where the original document file (or the document management system that manages the original document file) has information on the last updater or the update date and time for each document element, the information is registered in the item of the last updater or the update date and time in the element property. Ina normal case where the file of the original document has only the last updater and the update date and time in a document unit, values of the last updater and the update date and time of the document when the change of the content of the document element is detected are registered in the items of the last updater and the update date and time of the document element included in the document in the element property. Whether or not the content of the document element has been changed is determined by comparing the element content or the content characteristic of the document element obtained in S12 with the element content or the content characteristic of the document element in the database having the identical element ID.

The acquisition date and time refers to the date and time on which the processor 102 has acquired the document element last. The acquisition date and time is identical to the acquisition date and time of the document including the document element. The storage location refers to information of specifying the document management system in which the document element has been originally stored, and is identical to the storage location of the document including the document element.

In S16 of the procedure of FIG. 4 described above, information on each item of such element property is registered in the database. In S24, the processor updates the value of each item of the element property of the document element of which the change has been detected, to a value corresponding to the content of the change.

In a case where the document is acquired from an external document management system (for example, document management system outside the internal network 40), acquiring information on all items of the document property and the element property illustrated in FIGS. 6 and 7 for the above document may not be possible. Such an item is set to a null value, or a value obtained by the document service system 100 based on another type of information is set. For example, for a document acquired from the law management system 60, difficulty in obtaining information on the creator, the creation date and time, the last updater, and the update date and time from the document or the law management system 60 is considered. In this case, the items of the creator, the creation date and time, and the last updater may be set to null values. In a case where the change of the document element in the acquired document has been detected in S20 of the procedure in FIG. 4, the document service system 100 may set the date and time of the acquisition to the update date and time of the document element and the document.

The item group of the document property and the element property illustrated in FIGS. 6 and 7 are only examples. The document property and the element property are not required to include all of the illustrated items, and may include items that are not illustrated.

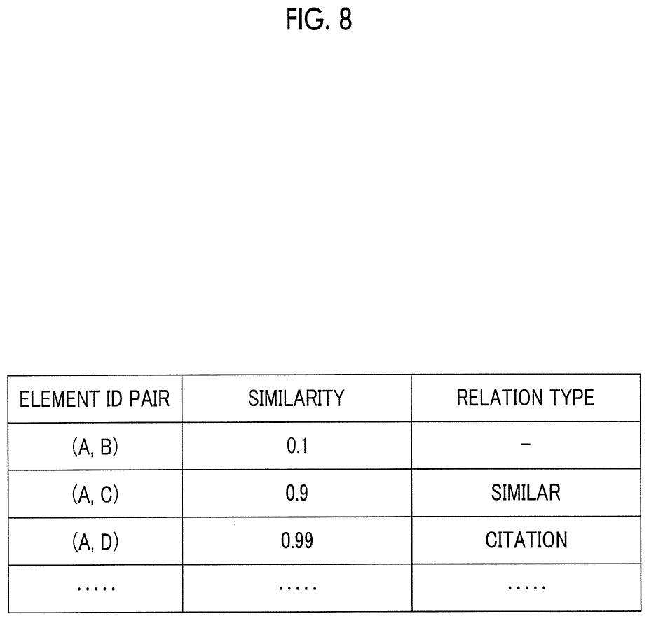

FIG. 8 illustrates relation information between document elements registered in the database. The relation information illustrated in FIG. 8 is associated with a pair of element IDs of two document elements. The relation information includes a value of the similarity of the content between the two document elements and the type of relation between the document elements, which is determined from the value. In the example, the types of relation between document elements are classified into several types in accordance with the magnitude of the similarity of the content between the document elements. For example, in a case where the similarity of the content between the document elements is equal to or greater than 0.95 (that is, 95%), the type of relation between the document elements is named “citation”. The type of relation in a case where the similarity of the content between the document elements is equal to or greater than 0.80 and smaller than 0.95 is named “similar”. In a case where the similarity is equal to or greater than 0.60 and smaller than 0.80, the type of relation is named “reference”. Ina case where the similarity is smaller than 0.60, the two document elements are determined to be unrelated.

Although not illustrated in FIG. 8, the date and time on which the similarity or the type of relation is determined may be further registered in the relation information.

In S17 and S26 in the procedure of FIG. 4, the similarity between the document elements and the type of the relation corresponding to the similarity are determined, and the values are registered in the relation information illustrated in FIG. 8.

The relation information illustrated in FIG. 8 is merely an example. As the relation information, information that includes similarity but does not include the type of relation may be used, and conversely, information that does not include similarity but includes the type of relation may be used.

Services Provided by Document Service System

An example of a service provided by the document service system 100 using the constructed database will be described.

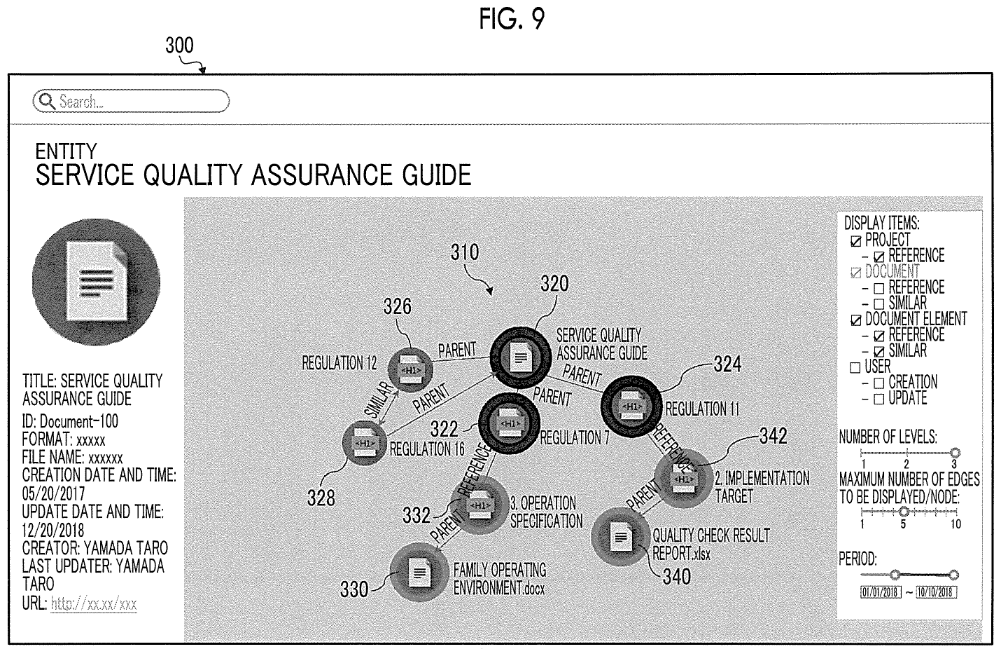

FIG. 9 illustrates an information providing screen 300 provided by the document service system 100 to the user. The information providing screen 300 provides information on document elements 332 and 342 related to changed document elements 322 and 324 among documents 320 designated by a user. The information is provided in a form of a graph 310 of a relation between the document 320 and the document elements 322, 324, 332, and 342.

All document elements related to the changed document elements 322 and 324 are not displayed on the information providing screen 300, but only a document element of which the user is a participant (for example, person who has created or updated the document element) is displayed. For the document element of which the user is a participant, the user is expected to perform a change operation in response to the change of the document elements 322 and 324. Thus, the user is provided with the information on the document element. On the contrary, for the document element of which the user is not the participant, a possibility that the user does not perform a corresponding operation such as correction even though the information is provided to the user is high. Thus, providing the information is not performed.

Here, an example in which a creator or an updater included in the element property of the document element is provided as the participant of the document element is described. In addition, a user or a user group having an edit authority for the document element or a document including the document element may be set as the participant of the document element.

In the example illustrated in FIG. 9, a document designated by the user is a document having a document name of “service quality assurance guide”. In the document, a document element 322 having an element name of “Regulation 7” and a document element 324 having an element name of “Regulation 11” are detected as the changed document elements. Whether or not the document element has been changed may be determined based on, for example, whether or not the document element is updated within a period that goes back by a predetermined length (for example, one month) from the current time. That is, in a case where the last update date and time of the document element is within the period, “the document element has been changed” is determined. In a case where the last update date and time is before the period, “the document element has not been changed” is determined. The length of the period may be designated by the user. The user may be able to designate both the start and end of the period. A designation field of “period” at the lower right portion of the information providing screen 300 is used for designation of the user.

In the example illustrated in FIG. 9, a document element 332 having a relation of “reference” to the changed document element 322 is provided. The document element 332 is a document element belonging to a document 330 having a document name of “family operating environment.docx” and has an element name of “3. operation specification”. A document element 342 having a relation of “reference” to the changed document element 324 is provided. The document element 342 is a document element belonging to a document 340 having a document name of “quality check result report.xlsx” and has an element name of “2. implementation target”.

In the example illustrated in FIG. 9, document elements 326 and 328 having a relation of “similar” to each other are shown in a document element group of the document 320.

The graph 310 shows a node group indicating the documents 320, 330, and 340, a node group indicating document elements 322 to 328, 332, and 342, and an edge group indicating a relation between the nodes. A text string indicating the type of relation indicated by an edge is displayed near each edge. For example, a text string of “reference” is shown at an edge indicating the relation between the document elements 322 and 332. A text string of “similar” is shown at an edge indicating the relation between the document elements 326 and 328. For example, a text string of “parent” is shown at an arrow-like edge extending from the document element 322 to the document 320. This indicates that the document 320 is a parent in the tree structure as viewed from the document element 322.

In the graph 310, the nodes of the changed document 320 and the changed document elements 322 and 324 are highlighted in a special display form indicating that the change has been performed.

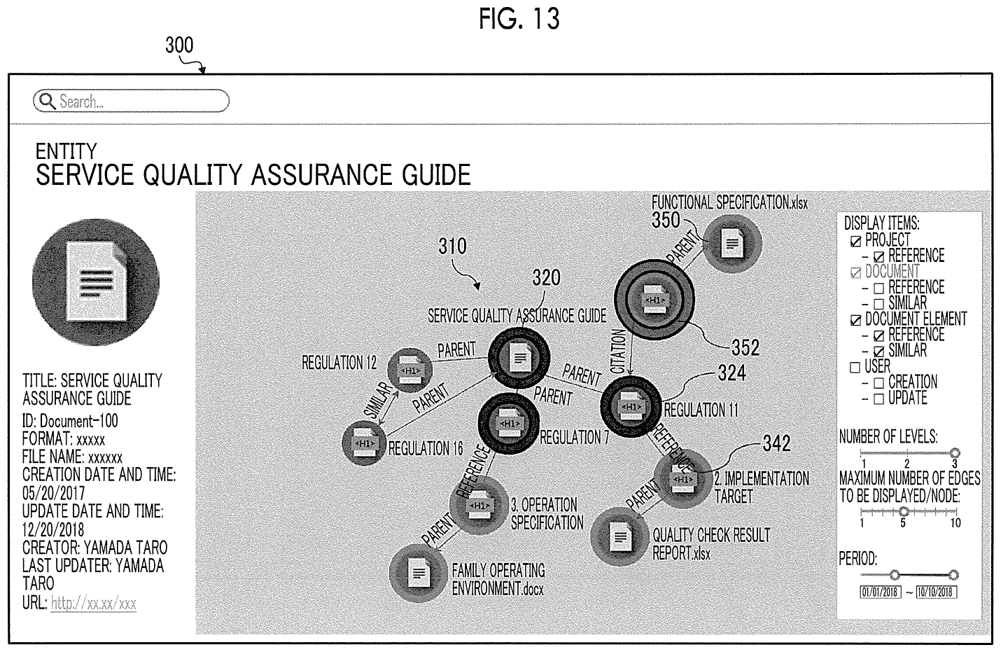

The document elements 332 and 342 related to the changed document elements 322 and 324 and the nodes of the documents 330 and 340 that are the parents of the document elements 332 and 342 are also highlighted in another display form. In the example illustrated in FIG. 9, the relation between the document elements 322 and 332 and the relation between the document elements 324 and 342 are both “reference”. Thus, the highlighted display forms of the document element 332 and the document element 342 are identical to each other. On the contrary, in a case where the two types of relation are different from each other, the highlighted display forms of the document element 332 and the document element 342 are different from each other. For example, as illustrated in FIG. 13 described later, a node of the document element 352 having a relation of “citation” to the changed document element 324 is displayed in a display form which is more prominent than that for the “reference” relation. Since the similarity of the content between the two document elements is much higher in “citation” than in “reference”, the necessity to correct the content in response to the changed document element is considered to be much higher in “citation”.

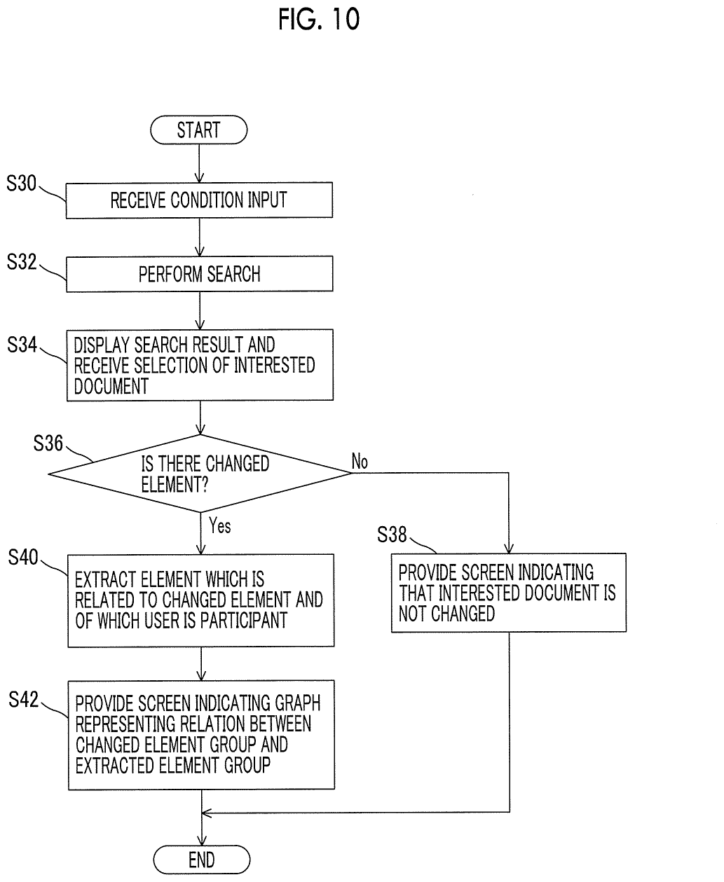

FIG. 10 illustrates an example of a processing procedure of creating the information providing screen 300 illustrated in FIG. 9.

In the procedure of FIG. 10, the processor 102 of the document service system 100 provides an input screen for inputting search conditions and the like to the client 30 in a form of a web page, for example. The processor receives the input of the search conditions and the like from the user (S30). The processor 102 searches the database for a document that satisfies the input search condition (S32). The processor provides the client 30 with a screen showing a list of documents as the search result, and receives the selection of the interested document from the user (S34). FIG. 9 illustrates an example of a case where the user selects the document 320 “service quality assurance guide” as an interested document.

The processor 102 examines the element property of each document element belonging to the interested document selected by the user, to specify the document element which has been changed within a predetermined period and determine whether there is a changed document element (S36). In a case where there is no changed document element in the interested document, the processor 102 generates a screen indicating that there is no changed document element in the interested document, and causes the client 30 to display the screen (S38).

In a case where the determination result in S36 is Yes, the processor 102 obtains a document element related to the specified changed document element from the relation information in the database (see FIG. 8). The processor extracts a document element of which the user is a participant among the obtained document elements (S40). The extraction may be performed with reference to the element property of the obtained document element. The processor 102 generates a graph 310 indicating the relation between a set of the changed document element obtained in S36 and the document to which the obtained document element belongs, and a set of the document element extracted in S40 and the document to which the extracted document element belongs. Then, an information providing screen 300 including the graph 310 is provided to the client 30 (S42). The processor 102 determines the display mode of the node for each document element to be displayed on the graph 310, in accordance with whether or not the document element is changed, or the type of relation between this document element and the changed document element.

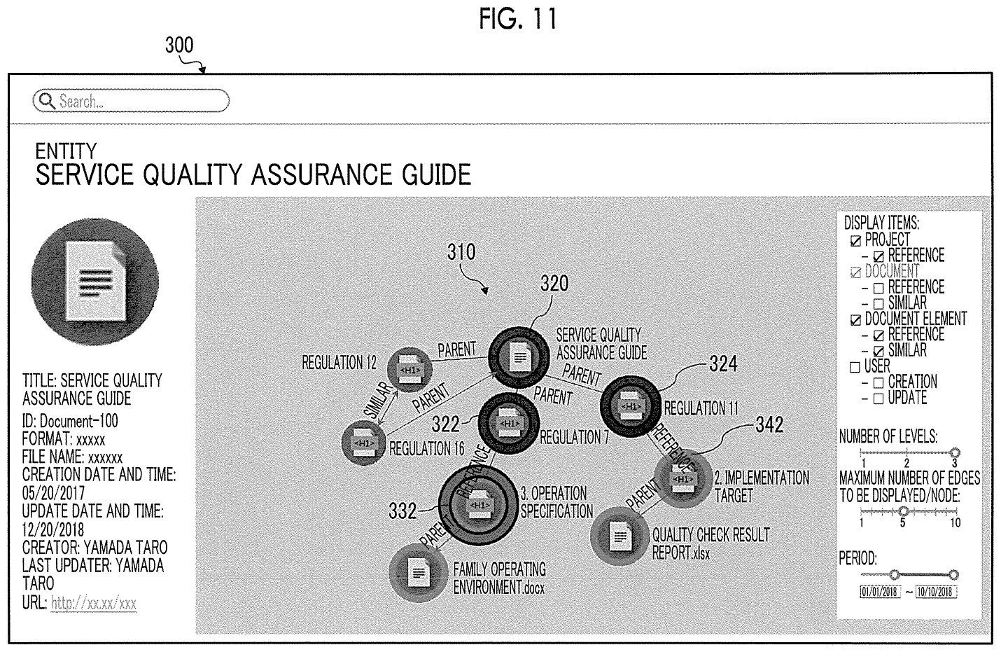

FIG. 11 illustrates another example of the information providing screen 300 provided by the document service system 100 to the user.

In the graph 310 illustrated in FIG. 11, among the document elements 332 and 342 of which users are participants and which are related to the changed document elements 322 and 324 in the interested document 320, the document element 332 of which the content is not changed after the change of the document elements 322 and 324 is highlighted. On the contrary, the content of the document element 342 related to the changed document element 324 has been changed after the change of the document element 324, and thus the document element 342 is not highlighted.

In a case where the document element 322 is changed, whether the document element related to the document element 322 is required to be changed is checked. In a case where the document element is required to be changed, the change is performed on the document element. Thus, the user is urged to check a document element by highlighting the unchanged document element among document elements related to the changed document element.

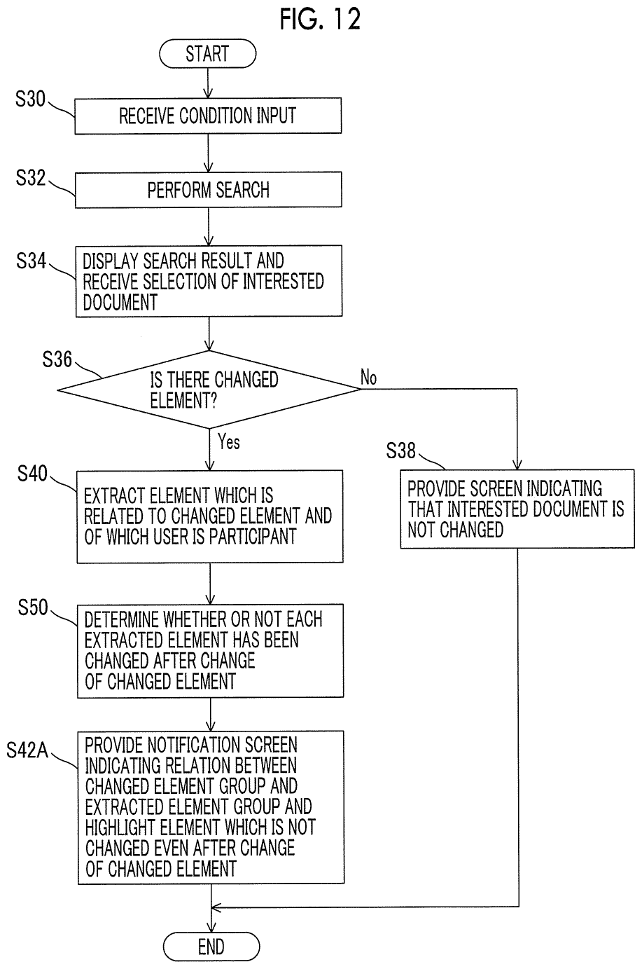

FIG. 12 illustrates an example of a processing procedure of creating the information providing screen 300 illustrated in FIG. 11. In the procedure of FIG. 12, steps of performing the similar processing to the procedure of FIG. 10 are denoted by the identical reference signs, and description thereof will be omitted.

In the procedure of FIG. 12, the processor 102 determines whether or not the document element extracted in S40 is changed after the corresponding changed document element has been changed (S50). For example, in a case where the last update date and time of the document element as a determination target is later than the last update date and time of the corresponding changed document element, the change is determined, in S50, to be completed, and otherwise the document element is determined, in S50, not to be changed. In the example of FIG. 10, since the last update date and time of the document element 332 is earlier than the last update date and time of the corresponding changed document element 322, the document element 332 is determined not to be changed.

The processor 102 generates the graph 310 and highlights the node of the document element determined, in S50, not to be changed in the graph 310 in a special display form for a notification indicating that the document element is not changed. Then, the information providing screen 300 including the graph 310 is provided to the client 30 (S42A).

The user selects the changed document element 322 and the node of the document element 332 which has been highlighted and not changed, on the information providing screen 300 displayed in the client 30. In response, the processor 102 of the document service system 100 provides the client 30 with a screen of displaying the latest content of the selected document element. The user checks the content of each document element on the screen, and determines whether the content of the document element 332 is required to be changed. In a case where the change of the document element 332 is determined to be required, the user performs a required change of the content of the document element 332. In response to the change, the processor 102 changes the element content or the content characteristic of the element property (see FIG. 7) of the document element 332 in the database. The processor 102 accesses the document management system that manages the document to which the document element 332 belongs, using the information on the storage location in the element property. The processor applies the change to a part corresponding to the document element 332 in the original document.

After a document element has been changed, the user may check whether a document element related to the changed document element is changed in response to the change. As a result, the user may determine that the change is not required. In this case, although the content of the latter document element has not been changed, the required check has already been completed. Thus, in a case where the highlight is displayed on the graph 310, the user is required to perform the useless check. Therefore, the processor 102 of the document service system 100 not only receives the edit of the content on the screen of displaying the content of the selected document element on the information providing screen 300, but also receives the designation of whether or not the content is checked. In a case where the designation that the check from the user is performed is made, the last update date and time of the document element is changed to the designated time. Thus, a situation in which the document element is highlighted to display being not changed on the subsequent information providing screen 300 does not occur.

FIG. 13 illustrates still another example of the information providing screen 300 provided by the document service system 100 to the user.

In the graph 310 illustrated in FIG. 13, in addition to the node group illustrated in FIG. 9, nodes of another document element 352 of which the user is a participant and which is related to the changed document element 322 and a document 350 (document name “functional specification.xlsx”) being the parent of the document element 352 are displayed. The document element 352 has a relation of “citation” to the changed document element 324. That is, the content of the document element 352 is identical or very close to the content of the document element 324. Although the other document elements 342 also has a relation with the identical document element 324, the relation is “reference” in which the similarity of the content between the document elements is much lower than “citation”. For this reason, the node of the document element 352 is highlighted in a display form indicating the relation of “citation”, and the display form is more conspicuous than the display form indicating the relation of “reference”.

In this example, in a case where the document service system 100 detects the document element 352 having a relation of “citation” to the changed document element 322, the document service system 100 updates the content of the document element 352 to match with the content of the changed document element 322. That is, for example, the content of the changed document element 322 is overwritten on the document element 352.

The update is performed on the element content (see FIG. 7) of the document element 352 in the database of the document service system 100. The similar update is performed on original data of the document 350 in the document management system (not illustrated) that manages the document 350 including the document element 352.

The update may be automatically performed by the document service system 100 without waiting for the check of the user. As another example, the user is required to check whether or not the update is performed. In a case where an instruction to perform update is obtained from the user, the document service system 100 may perform the update.

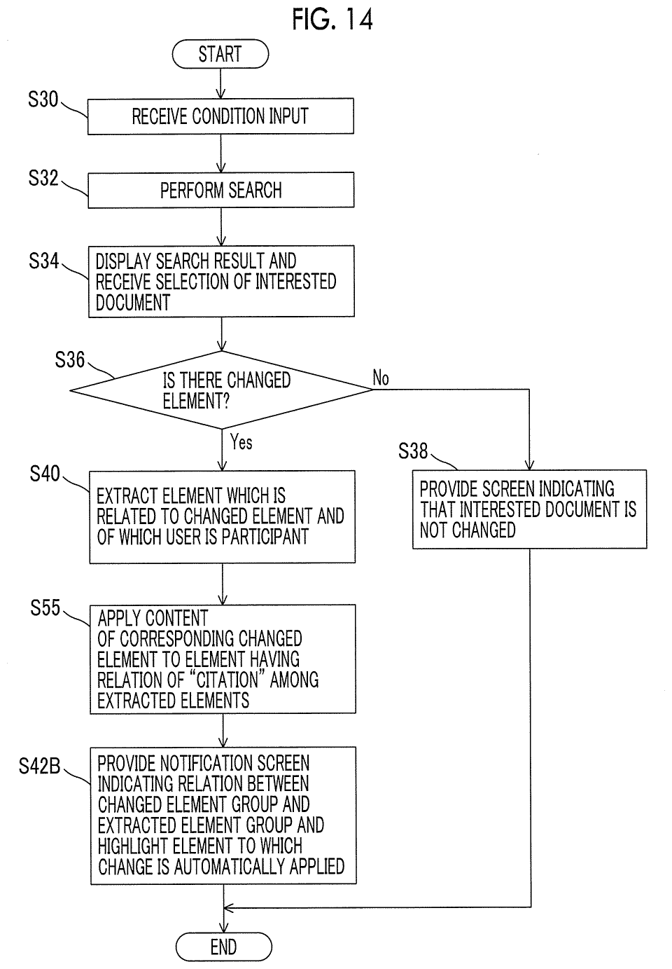

FIG. 14 illustrates an example of a processing procedure of the document service system 100 in the example of FIG. 13. In the procedure of FIG. 12, steps of performing the similar processing to the procedure of FIG. 10 are denoted by the identical reference signs, and description thereof will be omitted.

In the procedure of FIG. 14, the processor 102 examines whether or not a document element (referred to as a target element) having a relation of “citation” to the changed document element (referred to as a changed element) is provided among document elements extracted in S40. In a case where the target element is provided, the processor updates the element content of the target element in the database in the document service system 100 and the document in the document management system that manages the document including the target element, so as to match with the changed content of the changed element (S55). With this update, the content characteristic, the last updater, the update date and time, and the like of the element property of the target element in the database and the document characteristic, the last updater, the update date and time, and the like of the document property (see FIG. 6) of the document including the target element are also updated.

The processor 102 provides the client 30 with a screen for inquiring whether or not to update the target element. In a case where an instruction to perform the update is made on the screen by the user, S55 may be performed. In a case where an instruction indicating that the update is not performed is input from the user on the screen, the processor 102 does not perform S55.

The processor 102 generates the graph 310, and highlights the node of the document element having a relation of “citation” to the changed document element in the graph 310, in a special display form indicating “citation”. Then, the processor provides the client 30 with the information providing screen 300 including the graph 310 (S42B).

In the above description, the three examples of the information providing screen 300, which are illustrated in FIGS. 9, 11, and 13 are separately described. However, the display control in the three examples may be combined. For example, a document element having a relation to a changed document element is displayed in a display form corresponding to the type of relation, and, in a case where the latter document element is not changed after the former has been changed, the highlight indicating that the document element is not changed is added to the latter.

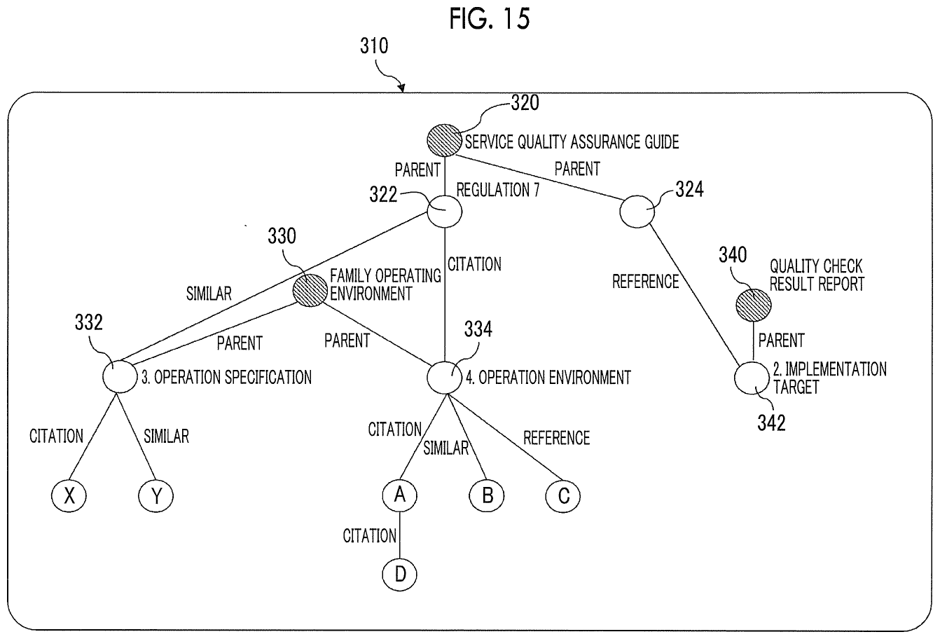

FIG. 15 illustrates another example of the graph 310 in the information providing screen 300 provided by the document service system 100 to the user.

The graph 310 illustrated in FIG. 15 is obtained by adding a document element 334 and nodes of document elements A, B, C, D, X, and Y to the graph 310 illustrated in FIG. 9 and changing the relation between the document elements 322 and 334 from “reference” to “similar”. As described above, “similar” has a higher similarity of the content between the document elements than similarity of “reference”.

The document element 334 (element name “4. operating environment”) is a document element in the document 330, and has a relation of “citation” to the changed document element 322 in the document 320. The document elements A, B, and C have a relation of “citation”, “similar”, and “reference” to the document element 334, respectively. The document element D has a relation of “citation” to the document element A.

The document elements X and Y have a relation of “citation” and “similar” to the document element 332, respectively.

As described above, the document elements A, B, C, D, X, and Y which do not have a direct relation to the changed document element 322 are also displayed on the graph 310 of FIG. 15. The display control of the document element which does not have a direct relation to the changed document element will be described below.

Here, in the following description, a changed document element in a document designated by the user is referred to as a changed element, and a document element having a direct relation to the changed element is referred to as a primary element. An element having a relation to the primary element is referred to as a secondary element, and a document element having a relation to the secondary element is referred to as a tertiary element. In the example of FIG. 15, the document elements 322 and 324 are changed elements, and the document elements 332, 334 and 342 are primary elements. The document elements A, B, C, X, and Y are secondary elements, and the document element D is a tertiary element. The secondary and tertiary elements do not have a direct relation to the changed element. In the following description, a relation between the changed element and the primary element is referred to as a primary relation. A relation between the primary element and the secondary element is referred to as a secondary relation. A relation between the secondary element and the tertiary element is referred to as a tertiary relation. In general, the relation between the (n−1)-th ordered element and the n-th ordered element is an n-ordered relation (n is an integer of 1 or more). However, in this case, the changed element is a zero-order element.

First, the processor 102 of the document service system 100 restricts the types of secondary relations to be included in the graph 310, that is, to be displayed, in accordance with the type of the corresponding primary relation. That is, as the type of the primary relation becomes “stronger”, the number of the types of the corresponding secondary relations included in the graph 310 are increased. The “weaker” relation is harder to be included in the graph 310. The primary relation is included in the graph 310 regardless of the type, but, regarding the secondary relation, only the type restricted in accordance with the type of the corresponding primary relation is included in the graph 310. In the three types of relations exemplified above, “citation”, “similar”, and “reference”, “citation” is the strongest, the next is “similar”, and the weakest is “reference”. The strength relation reflects the magnitude relation of the content similarity between the document elements forming the respective types of relations.

In the example of FIG. 15, in a case where the primary relation is “citation”, all three types of secondary relations are displayed. In a case where the primary relation is “similar”, only two types of secondary relations of “citation” and “similar” are displayed. In a case where the primary relation is “reference”, only one type of secondary relation “citation” is displayed.

For example, regarding the primary element 334 having a primary relation of “citation” to the changed element 322, all types of secondary relations “citation” (that is, relation to the secondary element A), “similarity” (that is, relation to the secondary element B), and “reference” (that is, relation to the secondary element C) are displayed.

On the other hand, regarding the primary element 332 having a primary relation of “similar” to the changed element 322, only two types of secondary relations “citation” (that is, relation to the secondary element X) and “similar” (that is, relation to the secondary element Y) are displayed. Even though there is a secondary element having a secondary relation of the type “reference” to the primary element 332, the secondary relation and the secondary element are not displayed on the graph 310.

Regarding the primary element 342 having a primary relation of “reference” to the changed element 324, the secondary relation and the secondary element are not displayed on the graph 310. For the primary element having the primary relation of “reference” to the changed element, the secondary relation of the type “citation” being the strongest may be displayed. However, in the example of FIG. 15, the secondary element having a secondary relation of “citation” to the primary element 342 is not provided. Thus, such a secondary element is not displayed. Even though the secondary element having a relation of “similar” or “reference” to the primary element 342 is provided, this secondary element is not displayed on the graph 310.

The processor 102 may determine the upper limit value of n of the n-th ordered relation included in the graph 310, in accordance with the type of the primary relation.

In the example of FIG. 15, regarding a relation extending from the primary relation of “citation” between the document elements 322 and 334, the relation up to the third order in maximum is included in the graph 310. On the contrary, regarding a relation extending from the primary relation of “similar” weaker than “citation”, the relation is included in the graph 310 only up to the second order. Since the primary relation between the document elements 322 and 332 is “similar”, even in a case where a tertiary element having a strong tertiary relation such as “citation” to the secondary element X related to the primary element 332 is provided, the tertiary relation and the tertiary element are not displayed on the graph 310.

In the example of FIG. 15, even though a document element is related to the changed document element in the document searched in S32, the document element included in the identical document (that is, searched document) to a document of the changed document element is not displayed on the graph 310 provided for the user. This is because the user does not normally have an edit authority for the searched document or the document element in the searched document. However, for each document element related to the changed document element, whether or not the user has an edit authority is checked. In a case where the user has the edit authority, even the document element in the identical document to the document for the changed document element may be displayed on the graph 310.

Another Example of Service

In the example described above, the document service system 100 simply records the change of the document element in the database at a time point at which the document service system detects the change of the document element. Information on the change is provided to the user at a time point at which the user designates a document including the document element, and the information providing screen 300 for the document is provided to the user in response to the designation.

As another example of this, processing of notifying a participant of another document element having a relation to a document element in a case where the document service system 100 detects that the content of the document element has been changed will be described below.

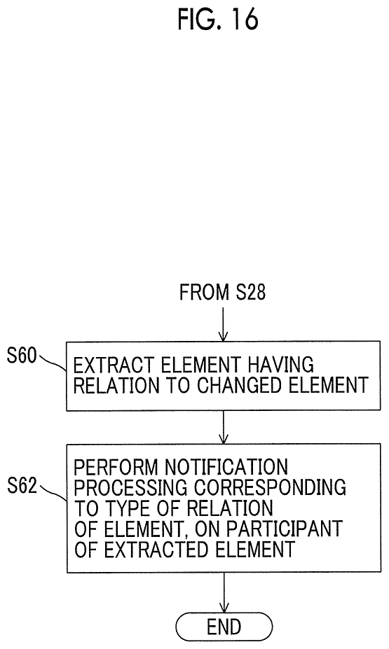

FIG. 16 illustrates an example of the procedure of this processing. The procedure of FIG. 16 illustrates a group of steps following S28 in the procedure illustrated in FIG. 4.

In the procedure of FIG. 16, in a case where the processor 102 detects the changed document element in S22 (see FIG. 4), the processor 102 extracts a document element group having a relation to the changed document element from relation information (see FIG. 8) in the database (S60). The processor 102 obtains information on a participant of the document element from the database for each extracted document element and notifies the participant of the change in a notification method corresponding to the type of relation (S62). A plurality of methods, for example, as follows are provided as a method of notifying the participant: a method of displaying the notification in a notification field on a portal page displayed in a case where the participant logs into the document service system 100; a method of display a message for causing the change to be known, on a screen such as the information providing screen 300 provided to the participant by the document service system 100 in a form of a pop-up screen; and a method of transmitting an e-mail to an e-mail address of the participant, which has been registered in the document service system 100 by the participant. The notification field is not displayed so long as the participant does not log into the document service system 100. However, the notification by e-mail reaches the participant even in a period in which the participant does not log into the document service system 100. Thus, the e-mail is more noticeable to the participant. In S62, the notification is performed by a method which is more noticeable to the participant as the type of the relation is stronger. For example, in a case where the type of the relation is “reference” and “similar”, only display in the notification field on the portal page of the participant is performed. However, in a case where the type of the relation is “citation” being stronger than others, the participant is notified by e-mail in addition to the display into the notification field.

The exemplary embodiment described above are merely exemplary, and various modifications may be made within the scope of the present disclosure.

For example, in the exemplary embodiment, the type of the relation between the document elements is determined in accordance with the similarity of the content between the document elements, but this is just an example.

For example, a user who has created or updated a document element may register another document element having a relation with the document element and the type of the relation in the document service system 100.

A device that provides a user with a function of editing a document (for example, a document editing application provided by the client 30) may determine a relation between document elements in accordance with an operation performed by the user while the user is editing a document element, and the device may register the determined relation in the document service system 100. For example, in a case where the user copies a document element a in a document A opened on a screen of the device to a document element b in another document B opened on the screen by a copy and paste operation, the device determines that the document element b has the type of relation of “citation” to the document element a. Then, the device registers the relation of “citation” in the document service system 100. For example, in a case where another document element d is opened on the screen (copy and paste of the document elements d to c is not performed) while the user is editing a document element c opened on the screen, the device determines that the document element c has a relation of “reference” to the document element d.

Exemplary Embodiment of Association Between Document Elements

In the above-described example, descriptions are made focusing on a method of determining the type of relation based on the similarity between contents of the document elements, as a method of associating the document elements (that is, determining the type of relation between the two document elements) with each other.

Another method of associating document elements with each other will be described below. This method focuses on changes in a document element. That is, in the method, a difference between two versions (old version and new version) of a document element is regarded as one of characteristics of the document element, and the relation between document elements is determined based on a similarity between the differences. A similarity between a difference between two versions (old version and new version) of a certain document element A and a difference between two versions (old version and new version) of another document element B is referred to as a difference similarity below.

The relation between document elements may be determined based only on the difference similarity, or may be determined based on both the above-described similarity between the contents of the document elements and the difference similarity. Attributes of the document elements may be applied to determine the relation between the document elements.

In one example, the attribute of a document including the document element is directly used as the attribute of the document element used as a material for determining the type of relation between the document elements. The attributes of a document, which are used as the attributes of the document element include a storage location, a creator, the creation date and time, the last updater, the update date and time, the acquisition date and time, a search tag assigned to the document by a person, and the like.

An attribute unique to a document element may be used as the material for determining a relation between document elements. For example, in a case of a system that manages the history of creation or update for each document element, attributes such as a creator, the creation date and time, the update date and time, and the last updater of the document element may be recorded.

Regarding the attribute used to determine the relation, one type or a combination of a plurality of types (for example, combination of a storage location and a creator) may be provided.

The types of relation between document elements include, for example, citation, being similar, and reference. The type of relation may be freely defined by the user of the system. A case where there is no relation between document elements may be defined as one of the types of relation (for example, type named “unrelated”) between document elements.

An example of a method of determining the type of relation between document elements by using an AI (artificial intelligence) will be described below. The AI (not illustrated) is built in the document service system 100 (see FIG. 1) or in a device that can communicate with the document service system 100. A method of mounting the AI is not particularly limited. Any known machine learning method such as a regression method (for example, a neural network and a support vector machine), or a method using a tree such as a decision tree may be used. The AI may be configured as software, configured as a hardware circuit, or configured as a combination of a hardware circuit and software.

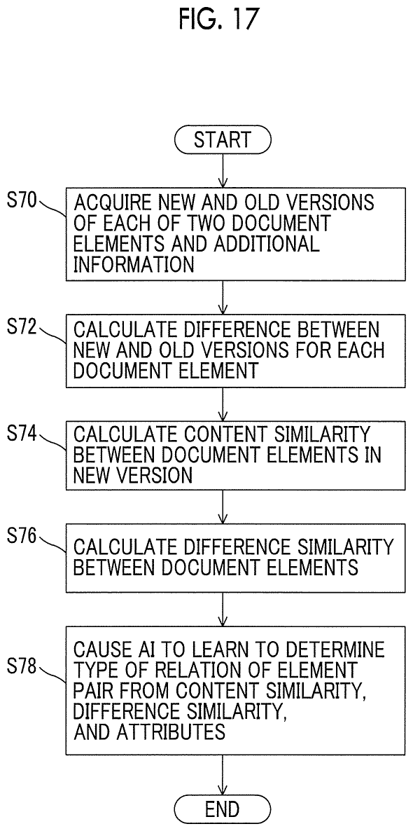

FIG. 17 illustrates an example of a processing procedure of causing the AI to determine the type of relation between document elements by machine learning. Description will be made below on the assumption that the processor 102 in the document service system 100 performs the processing procedure. However, this is just an example, and a learning system for causing the AI to perform learning may perform the processing procedure. In this case, the document service system 100 uses the learned AI.

In the processing procedure, the processor 102 acquires learning sample data (S70). The sample data includes two versions (new and old versions) of data and additional information for each of two document elements. The additional information includes the attribute of each of the two document elements and information on the type of relation between the document elements. The information on this type of relation is used as teacher data in a case where the AI is caused to perform learning. For example, such information is set for a pair of the two document elements by a person in advance. Multiple pieces of such sample data are prepared, and the processing in FIG. 17 is repeated on the multiple pieces of sample data.

Then, the processor 102 obtains a difference between an old version and a new version of each document element included in the sample data (S72). The difference obtained here refers to a pair of the content in the old version and the content in the new version of a part of the document element, which has been changed from the old version to the new version. The obtained difference data, that is, the pair of the content in the old version and the content in the new version is stored in the memory 104 or the auxiliary storage device 106 (referred to as “the memory 104 and the like” below) in association with the ID of the document element.

In a case where a part changed in the document element is a numerical value, the processor 102 may specify the meaning indicated by the changed part, that is, the numerical value, by natural language analysis. Then, the processor stores the meaning in the memory 104 and the like in association with the pair of the numerical value being the difference data. In many cases, a word or a phrase representing the meaning of the numerical value may be provided in the vicinity of the numerical value in the document element. Thus, with the natural language analysis, the processor may specify the word or the phrase related to the numerical value, and specify the meaning of the word or the phrase, as the meaning of the numerical value.

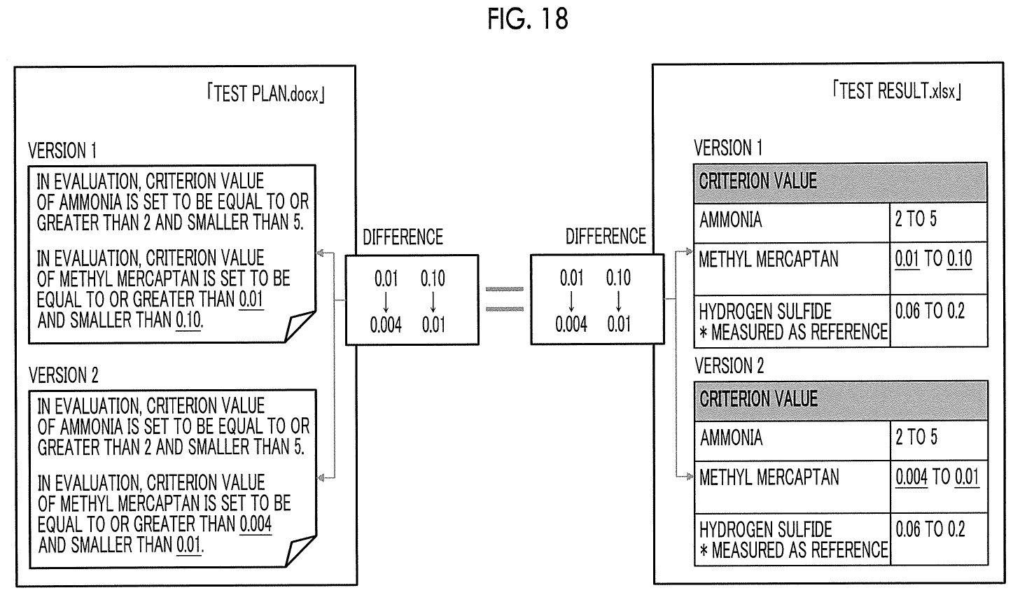

For example, FIG. 18 illustrates the contents of Version 1 and Version 2 of a document element in a document having a file name of “test plan.docx”. A lower limit value “0.01” of a criterion value of methyl mercaptan is changed to “0.004”, and an upper limit value “0.10” is changed to “0.01”, between both the two versions. Thus, the difference data between both the two versions refers to two pairs being a pair of “0.01” in the old version and “0.004” in the new version and a pair of “0.10” in the old version and “0.01” in the new version. The processor 102 stores the two pairs, as difference data, in the memory 104 and the like. Words of “methyl mercaptan”, “criterion value”, and “being equal to or greater than” are provided before and after the numerical value “0.01” in Version 1 and the numerical value “0.004” in Version 2. In this context, the processor 102 determines, by natural language analysis, that the numerical values “0.01” and “0.004” have the meaning of “the lower limit of the criterion value of methyl mercaptan”. Then, the processor stores the meaning in the memory 104 and the like, in association with the pair of the numerical value. Similarly, the processor 102 obtains that the meaning of the pair of “0.10” in the old version and “0.01” in the new version is “the upper limit of the criterion value of methyl mercaptan”, by natural language analysis. Then, the processor stores the meaning in the memory 104 and the like, in association with the pair.

A document element in a document of “test result.xlsx” illustrated on the right side of FIG. 18 is a table. The lower limit of the numerical value of methyl mercaptan is changed from “0.01” to “0.004”, and the upper limit of the numerical value of methyl mercaptan is changed from “0.10” to “0.01”, between Version 1 and Version 2 in the table. The processor 102 analyzes the headings of rows and columns in the table. Thus, the processor 102 recognizes that this table indicates the criterion value, and that items in the first, second, and third rows indicate criterion values of ammonia, methyl mercaptan, and hydrogen sulfide, respectively. “˜” is shown between two numerical values in the column of the value of each item. Thus, the processor 102 recognizes that the numerical value on the left side of “˜” indicates the lower limit of the criterion value, and the numerical value on the right side of “˜” indicates the upper limit of the criterion value. The processor 102 obtains information indicating that the lower limit of the criterion value of methyl mercaptan has changed from “0.01” to “0.004”, and information indicating that the upper limit of the criterion value of methyl mercaptan has changed from “0.10” to “0.01”, as difference data between Versions 1 and 2 in the table.

Returning to the description for FIG. 17, the processor 102 calculates the similarity (that is, the content similarity) between the contents of the two document elements (S74). In S74, for example, the processor 102 calculates the content similarity between the two document elements in a specific version (for example, new version) of the two (old and new) versions. As another example, the processor may calculate both the content similarity between the two document elements in the old version and the content similarity between the two document elements in the new version, and determine the content similarity based on the two content similarities. For example, the processor obtains an average value of the content similarity between the document elements in the old version and the content similarity in the new version, or a weighted average value focusing on the new version, as the content similarity between the two document elements. The content similarity may be obtained using a method in the related art such as the above-described method of obtaining the cosine similarity between document elements.

Then, the processor 102 calculates the similarity between the difference obtained in S72 for one of the two document elements and the difference obtained in S72 for the other (this similarity is referred to as the difference similarity below) (S76). The difference similarity may be obtained, for example, by a method similar to the method for the content similarity.

The processor calculates the difference similarity between two document elements in Versions 1 and 2 illustrated in FIG. 18, for example, in a manner as follows. In the example, the difference data for each of the two document elements includes two pairs of new and old numerical values. The processor 102 obtains the difference similarity between the two document elements by calculating the similarity between the pairs having the identical meaning, and summing (for example, averaging) the similarities of the two pairs. More specifically, the processor obtains the similarity in the pair of the new and old lower limit values of the criterion value of methyl mercaptan and the similarity in the pair of the new and old upper limit value, between the document element in the document of “test plan.docx” and the document of “test result.xlsx”. Regarding the pair of the new and old lower limit values of the criterion value of methyl mercaptan, the pairs completely coincide with each other in the two documents. Thus, the similarity is 100%. Similarly, the similarity of the pair of the old and new upper limit values of the criterion value between the two documents is also 100%. The difference similarity between the two document elements is calculated, for example, as 100%, which is the average of the two similarities.

The example in FIG. 18 means a case where numerical pairs representing a difference between two versions of a numerical value having the identical meaning coincide with each other between two document elements. On the contrary, in a case where the pairs do not coincide with each other between the two document elements, the processor 102 calculates the similarity between the pairs from the distance between the numerical values of the document elements in the old version and the distance between the numerical values of the document elements in the new version. For example, a function of increasing the similarity as the difference between the numerical values is reduced is used to calculate the similarity. In this function, in a case where the difference between the numerical values is 0, the similarity is 100%. In this function, the similarity is reduced as the difference between the numerical values increases. The similarity between pairs of new and old numerical values may be obtained by summing (for example, averaging) the similarity corresponding to the difference between the numerical values in the old version and the similarity corresponding to the difference between the numerical values in the new version. In a case where a plurality of new and old pairs are included in difference data indicating a difference between two document elements, the processor 102 obtains the resultant (for example, average value) obtained by summing the similarity obtained by the above-described method for each pair, for a plurality of pairs, as the difference similarity between the document elements.

Then, the processor 102 inputs the content similarity between the two document elements, which has been obtained in S74, the difference similarity obtained in S76, and one or more predetermined attributes of each document element, as input data. At this time, the processor 102 applies information indicating the type of relation between the two document elements to the AI as teacher data. The attribute of each document element and the information on the type of relation are included in the additional information acquired in S70. The processor 102 learns the AI by applying the input data and the teacher data to the AI (S78).

The steps of S72 to S78 are performed on each of multiple pieces of prepared sample data. Thus, in a case where the AI receives the input data formed by the content similarity, the difference similarity, and the attributes of the document elements, the AI performs learning to output the type of relation between the document elements.

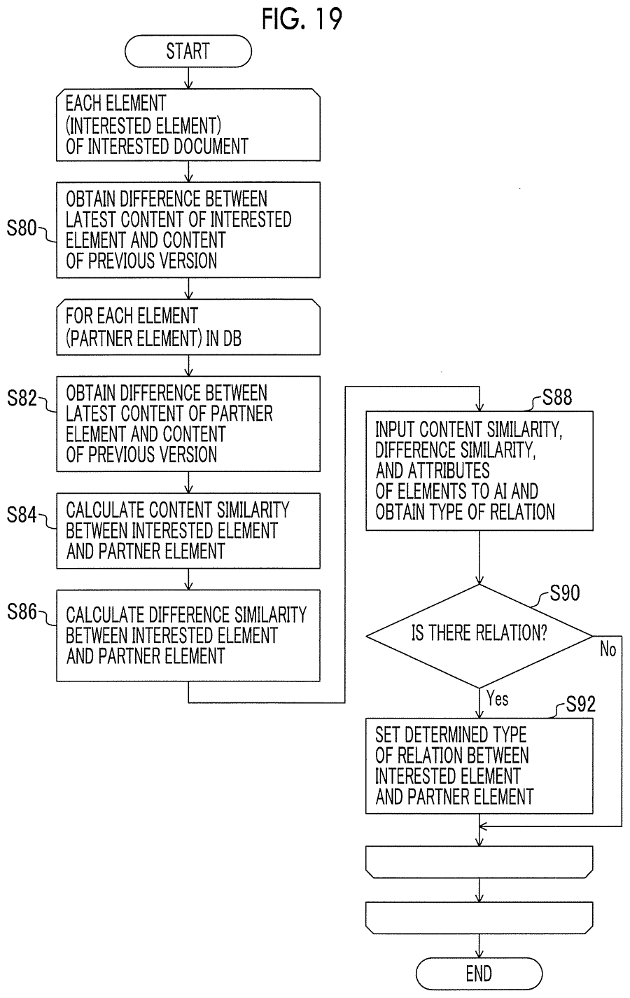

Next, an example of a processing procedure of obtaining the type of relation between document elements using the learned AI will be described with reference to FIG. 19. The processing procedure is performed by the processor 102 in the document service system 100. The processing procedure is an example of the detailed processing of S26 in a procedure of constructing and maintaining the database, which is illustrated in FIG. 4. In S26 of FIG. 4, the processor calculates the content similarity between document elements and obtains the type of relation from the content similarity. On the contrary, in the procedure of FIG. 19, the type of relation between the document elements is determined based on the content similarity, the difference similarity, and the attribute of each document element. The learned AI is used for the determination.

In the procedure of FIG. 19, the processor 102 performs the processing of S80 to S92 for each document element in an interested document (that is, document acquired in S10 of FIG. 4). The document element as a target of the processing of S80 to S92 is referred to as an interested element below.

The processor 102 calculates difference data between the content of the acquired interested element (the content is the latest version of the content of the interested element at this time) and the content of the version immediately before the interested element (S80). The data content of the difference data and a method of obtaining the data content may be similar to the data content and the method in the description for the procedure in FIG. 17. The procedure is an example of the processing of S26 in the procedure of FIG. 4, and thus the change in this time has been found for the interested element. Thus, the content of the interested element in a version immediately before this version is the content of the interested element before the change, which is stored in the database of the document service system 100.

Here, the document service system 100 is assumed to store at least the previously acquired content of the interested element in the database. Further, the document service system 100 may store information on the content acquired in each past time for the interested element. The content acquired in each time may be stored in association with information on the date and time on which the acquisition has been performed. In addition, instead of storing all the contents of the interested element, which have been acquired in the past time, only the contents when the change is performed from the previous time may be stored. Although the interested element has been described above, the document service system 100 is assumed to similarly store the previous contents or the contents of a plurality of times in the past for all the document elements of all target documents.

Then, the processor 102 performs the processing of S82 to S92 for each document element (referred to as a partner element below) in the database. In the processing, the type of relation between the interested element and the partner element is registered in the database.

More specifically, the processor 102 firstly obtains difference data between the contents of the partner element in the latest version and in the previous version (S82). The latest version is assumed to be the latest content of the partner element, which is stored in the database. The previous version means the latest content which has been changed from the latest content, which is also stored in the database. The method for obtaining the difference data is similar to the method for the interested element.

Then, the processor 102 calculates the content similarity between the interested element and the partner element (S84). The content similarity may be calculated by a method identical to the method in S74 in the procedure of FIG. 17.

The processor 102 calculates the similarity between the difference data obtained in S80 for the interested element and the difference data obtained in S82 for the partner element, that is, calculates the difference similarity (S86). The difference similarity may be calculated by the identical method to the method in S76 of the procedure in FIG. 17.

Then, the processor 102 inputs the content similarity calculated in S84, the difference similarity calculated in S86, one or more predetermined attributes of the interested element, and one or more predetermined attributes of the partner element to the learned AI (S88). In response to the input, the AI outputs information on the type of relation between the interested element and the partner element.

Then, the processor 102 determines whether or not the type of relation output from the AI is other than “unrelated” (S90). In a case where the determination result is Yes, the processor 102 registers the value output by the AI, as the type of relation between the interested element and the partner element, in relation information in the database (S92). Thus, the value of the relation information in the database is updated to the value output by the AI. The relation information here is different from the relation information illustrated in FIG. 8 in that the field of the similarity is not included. In a case where the determination result in S90 is No, the processor 102 skips S92 or registers a value indicating unrelation, as the type of relation between the interested element and the partner element, in the relation information.

The above description is made on the assumption that the procedure in FIG. 19 is the detailed procedure of S26 of the procedure in FIG. 4. However, the procedure in FIG. 19 may be performed on the two input document elements regardless of the procedure in FIG. 4.

As described above, in the exemplary embodiment, the relation between the interested element and the partner element is determined considering the difference similarity between the two versions of the elements. As the difference similarity increases, the relation between the two elements is determined to become stronger. This is because document elements showing similar changes are considered to have a strong relation.

In the example of FIG. 18, the document element of the document “test plan.docx” is text data, but the document element of the document “test result.xlsx” is tabular data. Although there are differences in the format, the information contents represented by the two document elements are very similar. However, due to the difference in the format, the content similarity between the document elements does not have a very high value. For this reason, in a case where the type of relation between the two document elements is determined based on only the content similarity or based on the content similarity and the attribute of the document element, the type of relation is not very strong.

On the contrary, the similarity between the differences between Versions 1 and 2 of the two document elements, that is, the difference similarity, has a very high value. For this reason, the type of relation between the document elements, which has been determined in consideration of the difference similarity indicates a stronger relation than the type in a case where the difference similarity is not considered, and this is close to the actual relation between the information contents of the two document elements.

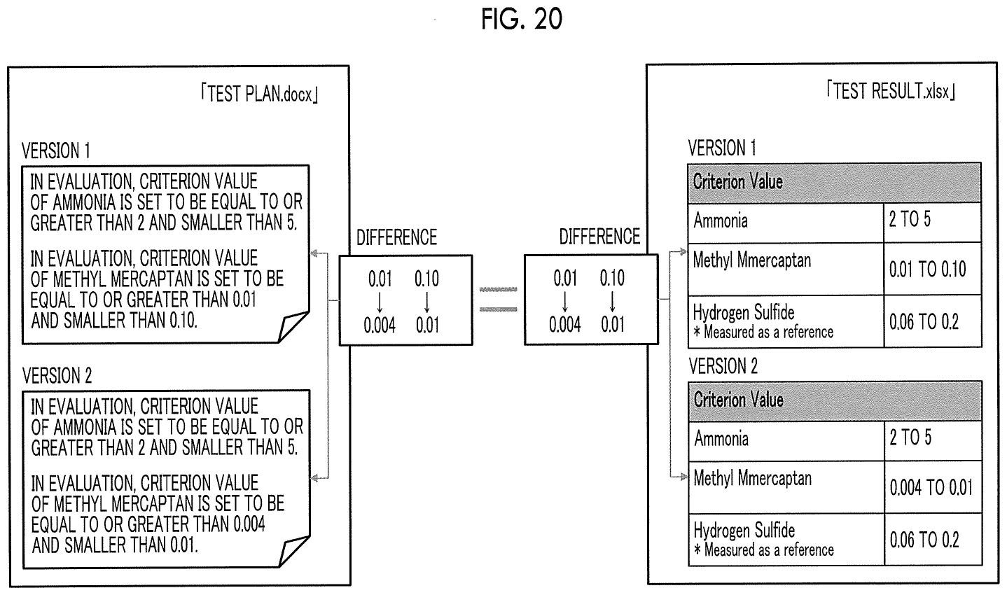

FIG. 20 illustrates an example in which the document element of the document “test result.xlsx” on the right side in FIG. 18 is changed to English. The document elements on the right side of FIG. 20 are exactly identical to the document elements on the right side of FIG. 18 except for the language. Thus, the information contents indicated by the two right and left document elements in FIG. 20 are very close. However, due to the language difference, the content similarity between the right document element and the document element (this is written in Japanese) of the left document “test plan.docx” has a low value. Therefore, the relation between the two document elements is not determined to be strong based on only the content similarity.

On the contrary, the difference between Versions 1 and 2 coincides with the difference between the two document elements. Thus, the difference similarity between the two document elements has a very high value. Therefore, in a case of considering the difference similarity in addition to the content similarity, the relation between the two document elements is determined to be strong more accurately than the relation in a case of not using the difference similarity.

Here, in a case of obtaining the difference data, the processor 102 may refer to a dictionary in order to specify the meaning of a part having a difference between versions. For example, the item name “Methyl mercaptan” of the difference part in the document element on the right side of FIG. 20 is understood to have the identical meaning to “methyl mercaptan” by referring to the dictionary. Thus, the difference between the value “0.10” of the left document element in the old version and the value “0.01” in the new version is associated with the difference between the value “0.10” of the right element in the old version and the value “0.01” in the new version, based on the determination that the above differences relates to “methyl mercaptan” together.

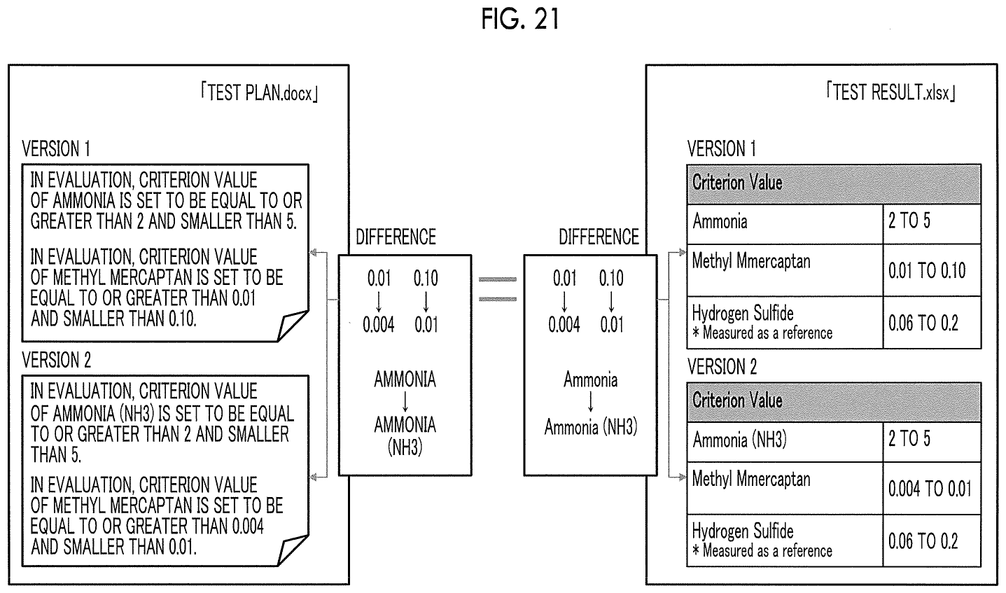

The examples in FIGS. 18 and 20 are examples in which the numerical values are changed between versions. However, FIG. 21 illustrates an example in which an additional description is provided between versions. The two document elements in Version 1 on the left and right sides in the example illustrated in FIG. 21 are identical to two document elements in the example in FIG. 20. However, in a case of the two document elements in Version 2, an addition description of “(NH3)” is added to the example in FIG. 20.

In the example, the processor 102 further detects a change from “ammonia” to “ammonia (NH3)” as a difference between the versions of the left document element, and detects a change from “Ammonia” to “Ammonia (NH3)” as a difference between the versions of the right document element. Because the identical additional description is provided to the left and right document elements, the similarity between the differences is high. Since the differences between the other numerical values also coincide with each other between the left and right document elements, the overall difference similarity between the left and right document elements has a very high value.

The examples of FIGS. 18, 20, and 21 are examples in which there is a difference in text data between versions. However, in the exemplary embodiment, a difference of data in formats other than text data is also set as a target.

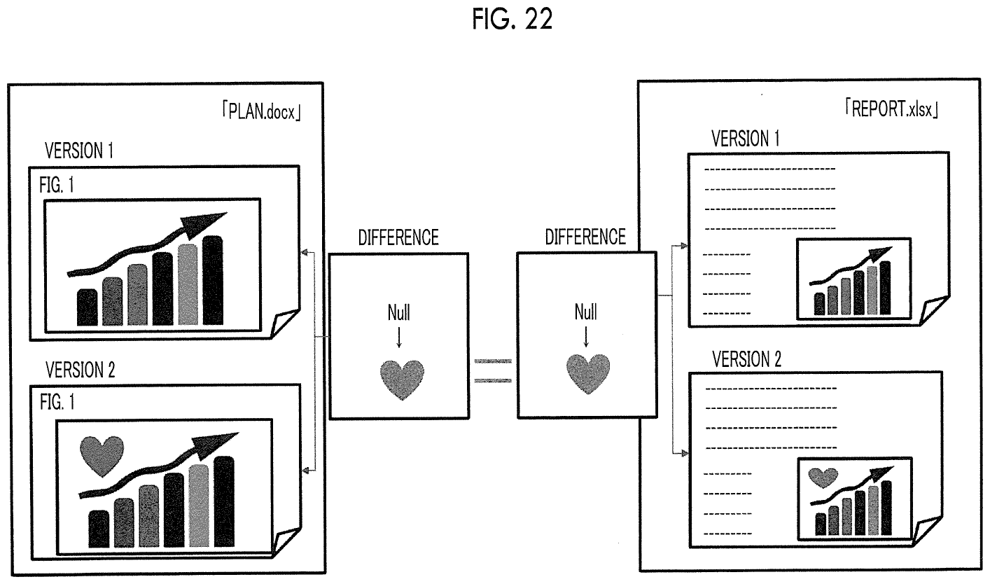

In the example illustrated in FIG. 22, the document element of the document “plan.docx” on the left is a figure with a caption “FIG. 1”, and the document element of the document “report.xlsx” on the right includes a figure and text. A heart-shaped mark which has not been in Version 1 is added to the left document element in Version 2. A text part is not changed between Versions 1 and 2 of the right document element, but there is a change in the figure, in which a heart-shaped mark has been added. Therefore, the difference between Version 1 and Version 2 of the document elements on the right and left is that the heart-shaped mark is added to a location (described as “Null” in FIG. 22) in which there is no symbol in Version 1. Thus, the difference similarity between the two document elements has a very high value.

As described above, a difference between versions can be obtained for a document element in a graphic data format, and a difference similarity between document elements can be obtained. Thus, the processing procedure of the exemplary embodiment illustrated in FIG. 19 can be applied to the document element in the graphic data format.

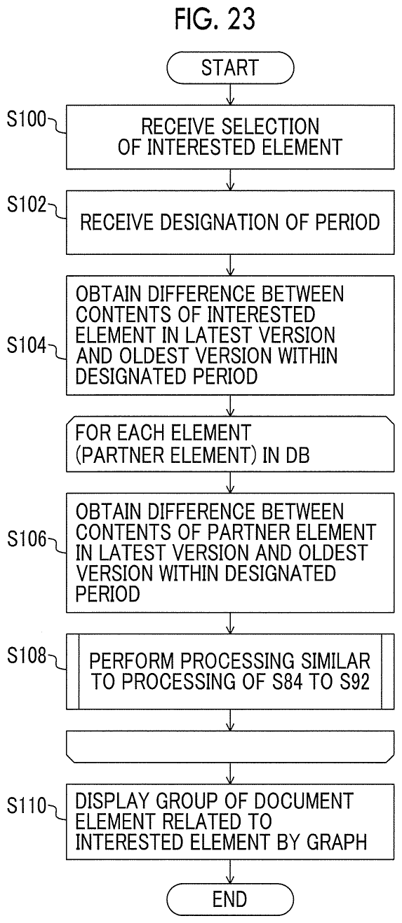

Next, another example of the processing procedure of obtaining the type of relation between document elements using the learned AI will be described with reference to FIG. 23.

In the procedure, the processor 102 receives a designation of an interested element from a user terminal, for example, via a network (S100). In the process of S100, for example, similar to the step group of S30 to S34 illustrated in FIG. 10, the selection of the document is received from the user, and the designation of the interested element from a document element group in the selected document by the user is received.

Then, the processor 102 receives a designation of a period from the user (S102). In S102, for example, the designation of the start and end of the period may be received in a field titled “period” at the lower right in the information providing screen 300 illustrated in FIG. 9. The start and end are designated, for example, by the date, or date and time. The period designated in S102 is referred to as a designated period.

Then, the processor 102 specifies the latest version and the oldest version of the interested element within the designated period, and obtains difference data between both the versions (S104). In the example, every time the system acquires a document element, information and the like such as the content of the document element are stored in the database of the document service system 100 in association with the date and time of the acquisition. In S104, the processor 102 specifies the version (that is, the oldest version) at a time point closest to the start of the period and the version (that is, the latest version) at a time point closest to the end, among contents of the interested element in the database at acquisition time points.

Then, the processor 102 performs the processing of S106 to S108 for each document element (referred to as a partner element below) in the database.

That is, the processor 102 specifies the latest version and the oldest version of the partner element within the designated period, and obtains difference data between the two versions (S106). Next, the processor 102 executes the identical processing to the steps S84 to S92 in the procedure of FIG. 19 (S108). Here, the content similarity between the interested element and the counterpart element determined in S108 (particularly, processing corresponding to S84 in FIG. 19) is the similarity between the contents of the latest versions of both elements within the designated period. With the processing in S108, the type of relation between the interested element and the partner element is determined.

The processing of S106 to S108 is repeated for all document elements in the database, and thus the type of relation between the interested element and another document element in the database in the period designated in S102 is obtained in consideration of the content similarity and the difference similarity.

Then, the processor 102 generates a graph indicating the relation between the interested element and a group of the other document elements, based on information on the type of relation between the interested element and another document element, which has been obtained by a step group up to this point. Then, the processor 102 provides the user terminal with the information providing screen including the generated graph (S110). The graph and the information providing screen to be provided are similar to the graph and the information providing screen illustrated in FIG. 9.

As described above, in the example of FIG. 23, the designation of the interested element and the designed period is received from the user, and the type of relation between the interested element and another document element is obtained in consideration of the difference (that is, change) between the latest version and the oldest version in the designated period.

In the example of FIG. 23, the designated period for obtaining the difference between the contents of the document elements is designated by a combination of the start and the end, but there is another example.

For example, in a case where the document management system such as the design document management system 10 provides a service for managing a workflow for a document, the start and the end of the designated period may be allowed to be designated at a stage of the workflow.

For example, in the design document management system 10, a design document creation workflow is assumed to be managed in a series of three stages: first draft creation, primary approval, and final approval. In a case where a staff in the design department creates and registers a first draft of a product design document on the design document management system 10, the first draft creation stage for the design document is completed, and the first draft is stored in the design document management system 10. A primary approval authority holder (for example, the leader of the product design team) who has the authority to give the primary approval to the design document checks the first draft. In a case where there is any deficiency, the holder instructs the staff in charge to correct the design document or corrects the first draft. Ina case where a design document satisfying the primary approval authority holder is obtained by the correction or the like, the primary approval authority registers the primary approval for the design document in the design document management system 10. As a result, the stage of the primary approval of the design document is completed, and the primary approved manuscript of the design document is stored in the design document management system 10. Then, a final approval authority holder (for example, the head of the design department) who has the authority to give the final approval to the design document checks the primary approved manuscript. In a case where there is any deficiency, the holder instructs the person who made the primary approval to correct the manuscript. In a case where a design document satisfying the final approval authority holder is obtained by the correction in response to the instruction, the final approval authority holder registers the final approval for the design document in the design document management system 10. Thus, the final approval stage of the design document is completed, and the completed manuscript of the design document is stored in the design document management system 10. The design document management system 10 manages the completed manuscript as a formal document of the design document.

As described above, in the design document management system 10, each version (that is, first draft, primary approved draft, and completed draft) of the document is stored in association with the stage of the workflow. Therefore, for the document element in the document managed by the design document management system 10, the processor 102 may receive the start and end of the period in a form of the stage in the workflow, in S102 of the procedure in FIG. 23. For example, in a case where a certain document element in a certain design document is designated as the interested element, in S102, for example, the designation of the designated period, in which the start is set to the primary approval stage, and the end is set to the final approval stage can be received. In this case, the oldest version of the interested element within the designated period refers to the content of the interested element in the primary approved document, and the latest version refers to the content of the interested element in the completed document.

In a case of document elements in a document, which have the identical partner elements in the design document management system 10, the designated period for the partner element in S106 in the procedure of FIG. 23 is a set of a start stage and an end stage on a workflow identical to the workflow for the interested element. For example, in a case where the designated period in which the primary approval is set as the start and the final approval is set as the end is designated for the interested element, in S106, a difference between the content of the partner element in the primary approved document of the partner element and the content of the partner element in the completed manuscript is obtained.

A document management system that manages the document including the partner element may use a workflow different from the design document management system 10 or may not use the workflow. In such a case, applying the start and end stages of the designated period for the interested element to the designated period for the partner element in S106 is not possible. Thus, the processor 102 may obtain the date or date and time of each stage of the start and end of the designated period designated for the interested element, and set a period represented by the two dates as the designated period in S106 for the partner element. Information on the date or the like at a time point in which processing of each stage is assumed to be performed on each document is registered in the document management system. In the above example, the difference between the latest version and the oldest version within the designated period is calculated. However, the exemplary embodiment is not limited to the difference between the latest and the oldest. A difference between any two versions within the designated period (that is, first version and second version generated in the designated period) may be obtained. The relation between both document elements may be determined based on the difference obtained for the two document elements.

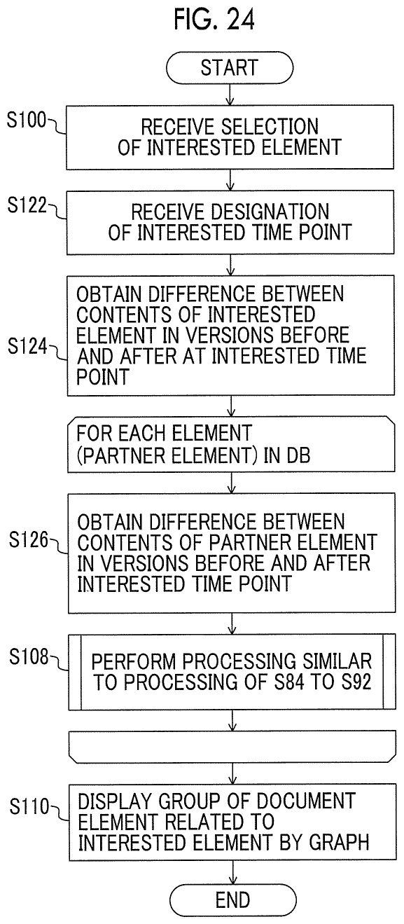

Next, still another example of the processing procedure of obtaining the type of relation between document elements using the learned AI will be described with reference to FIG. 24. In the procedure of FIG. 24, steps of performing processing similar to processing in the procedure of FIG. 23 are denoted by the identical reference numerals, and repetitive description will be omitted.

In the procedure, the processor 102 receives the designation of the interested element from the user terminal in S100 and receives the designation of the interested element from the user (S122). For example, the user designates the date (for example, a date on which the revised law is enforced) or the date and time on which the interested document is updated, as an interested time point.

The processor 102 specifies the version of the interested element immediately before the interested time point and the version immediately after the interested time point, and obtains difference data between the contents of both versions (S124). Next, the processor 102 performs the processing of S126 and S108 for each document element (referred to as a partner element below) in the database. That is, the processor 102 specifies the version of the partner element immediately before and after the interested time point, and obtains difference data between the contents of both versions (S126). Then, the processor 102 obtains the type of relation between the interested element and the partner element by performing processing similar to the step group of S84 to S92 in the procedure of FIG. 19 (S108).

After completing the repetitive processing of S126 and S108, the processor 102 generates a graph indicating the relation between the interested element and a group of other document elements in a manner similar to the procedure of FIG. 23. Then, the processor provides the user terminal with an information providing screen including the generated graph (S110).

In S122 of the procedure in FIG. 24, the designation of the interested time point may be received in a form of a stage on the workflow for the document to which the interested element belongs, instead of the date or the date and time. In this case, in S124, a difference between the versions of the interested element before and after the stage designated by the user is obtained. For example, in the example of the workflow of the design document management system 10 described with reference to FIG. 23, in a case where the primary approval stage is designated as the interested time point, in S124, the difference of the content of the interested element is obtained between the first draft and the primary approved manuscript. In a case where the partner element is a document element in a document that follows the identical workflow, in S126, a difference between versions of the partner document before and after the identical workflow stage designated to the interested time point for the interested element is obtained. In a case where the partner element is a document element in a document that does not follow the identical workflow, the processor 102 specifies the date or the like on which the stage at the interested time point is performed for the interested element. In S126, the processor may obtain the difference between the versions of the partner element immediately before and after the date and the like.

In the example of FIG. 24, the user explicitly designates the interested time point. Instead, in a case where the user selects the interested element, the processor 102 may specify a time point (that is, the latest change time point) at which the content of the interested element is changed last, and automatically determine the specified time point as the interested time point. The processor may present a list at the time point at which the content of the interested element has been changed, to the user, and cause the user to select the interested element from the list.

In the exemplary embodiment described above, the document element is an element that forms a document. Here, there may be a document in a larger unit having individual documents managed by the document management system, as constituent elements. In this case, the former individual document is a document element for the latter large unit document. For example, in a case where a hypertext configured with a plurality of documents linked by hyperlinks is regarded as a document of a large unit, the plurality of documents correspond to document elements in a case of being viewed from the hypertext.

Hitherto, the exemplary embodiment of the mechanism for associating document elements has been described above, but the exemplary embodiment described above is merely an example. Various modifications are possible within the scope of the present disclosure.

For example, in the processing procedures illustrated in FIGS. 19, 23, and 24, the type of relation between the document elements is determined using the AI, but the determination may be performed using an algorithm instead of the AI. The algorithm used at this time defines a procedure of determining the type of relation between two document elements from a combination of the content similarity, the difference similarity, and the attributes of the two document elements.

Further, determination of the type of relation between document elements does not need to use all of the content similarity, the difference similarity, and the attributes of the two document elements. For example, an example in which the type of relation is determined from a set of the content similarity and the difference similarity may be considered. An example in which the type of relation is determined only from the difference similarity, and an example in which the type of relation is determined from the set of the attribute of the document element and the difference similarity may be considered.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
perform difference extraction processing of extracting a difference between two versions of each of a first document element and a second document element, and
perform determination processing of determining a relation between the first document element and the second document element based on a similarity between the difference for the first document element and the difference for the second document element.

2. The information processing apparatus according to claim 1,
wherein the processor is further configured to receive a designation of a period, and
the difference extraction processing is processing of extracting a difference between a first version and a second version within a designated period for each of the first document element and the second document element.

3. The information processing apparatus according to claim 1,
wherein a plurality of steps for changing a content of the document element are defined in a system in which the first document element and the second document element are stored,
the processor is further configured to
receive a designation of any one of the plurality of steps from a user, and
the difference extraction processing is processing of extracting a difference between a version before a change according to the designated step is performed and a version after the change is performed, for each of the first document element and the second document element.

4. The information processing apparatus according to claim 1,
wherein, in a system that manages the first document element, a plurality of steps for changing a content of the first document element is defined, and information indicating a time point at which each of the plurality of steps for the first document element is performed is registered,
the processor is further configured to
receive a designation of an interested step among the plurality of steps, from a user, and
the difference extraction processing is processing of extracting a difference between a version of the first document element before the interested step and a version of the first document element after the interested step and extracting a difference between versions of the second document element before and after a time point at which the interested step is performed.

5. The information processing apparatus according to claim 1,
wherein the processor is further configured to
receive a designation of the first document element and receive an input of specifying information for specifying a change time point of the first document element, and
the difference extraction processing is processing of extracting versions of the document element before and after the change time point specified based on the specifying information, for each of the first document element and the second document element.

6. The information processing apparatus according to claim 1,
wherein the processor is further configured to
calculate a content similarity being a similarity of a content between the first document element and the second document element in a predetermined version of the two versions, and
in the determination processing, the relation is determined based on the difference similarity and the content similarity.

7. The information processing apparatus according to claim 2,
wherein the processor is further configured to
calculate a content similarity being a similarity of a content between the first document element and the second document element in a predetermined version of the two versions, and
in the determination processing, the relation is determined based on the difference similarity and the content similarity.

8. The information processing apparatus according to claim 3,
wherein the processor is further configured to
calculate a content similarity being a similarity of a content between the first document element and the second document element in a predetermined version of the two versions, and
in the determination processing, the relation is determined based on the difference similarity and the content similarity.

9. The information processing apparatus according to claim 4,
wherein the processor is further configured to
calculate a content similarity being a similarity of a content between the first document element and the second document element in a predetermined version of the two versions, and
in the determination processing, the relation is determined based on the difference similarity and the content similarity.

10. The information processing apparatus according to claim 5,
wherein the processor is further configured to
calculate a content similarity being a similarity of a content between the first document element and the second document element in a predetermined version of the two versions, and
in the determination processing, the relation is determined based on the difference similarity and the content similarity.

11. The information processing apparatus according to claim 1, further comprising:
a storage device that stores relation information indicating the relation between the first document element and the second document element,
wherein the processor is further configured to
update the relation information stored in the storage device to information indicating the relation determined in the determination processing.

12. The information processing apparatus according to claim 2, further comprising:
a storage device that stores relation information indicating the relation between the first document element and the second document element,
wherein the processor is further configured to
update the relation information stored in the storage device to information indicating the relation determined in the determination processing.

13. The information processing apparatus according to claim 3, further comprising:
a storage device that stores relation information indicating the relation between the first document element and the second document element,
wherein the processor is further configured to
update the relation information stored in the storage device to information indicating the relation determined in the determination processing.

14. The information processing apparatus according to claim 1,
wherein, in the determination processing,
the relation between the first document element and the second document element, which corresponds to a combination of a similarity between a difference between two versions of the first document element and a difference between two versions of the second document element, and attributes of the first document element and the second document element, is determined by an AI that has learned the relation between the two document elements, which corresponds to the combination of the similarity between differences between the two versions of each of the two document elements and the attributes of the two document elements, by machine learning in advance.

15. The information processing apparatus according to claim 1,
wherein, in the determination processing,
the relation between the first document element and the second document element, which corresponds to a combination of a similarity between a difference between two versions of the first document element and a difference between the two versions of the second document element, a similarity between contents of the first document element and the second document element, and attributes of the first document element and the second document element, is determined by an AI that has learned the relation between the two document elements, which corresponds to the combination of the similarity of the difference between the versions of each of the two document elements, the similarity between contents of the document elements in a predetermined version of the two versions, and the attributes of the two document elements, by machine learning in advance.

16. The information processing apparatus according to claim 1, further comprising:
a performing unit that performs processing on the second document element in accordance with the determined relation, in a case where the first document element is changed.

17. The information processing apparatus according to claim 16,
wherein, in a case where the relation between the first document element and the second document element is a first type of relation in which a similarity between the first document element and the second document element is equal to or greater than a first predetermined threshold value which is greater than 0, the processing is notification processing of notifying a participant of the second document element that the first document element is changed.

18. The information processing apparatus according to claim 16,
wherein, in a case where the relation between the first document element and the second document element is a second type of relation, the processing is processing of copying the changed first document element to the second document element, and
the second type of relation is a relation in which the similarity is equal to or greater than a second threshold value being a minimum value of the similarity, by which the first document element and the second document element are considered to be identical to each other.

19. The information processing apparatus according to claim 16,
wherein the processing is processing in which, on a display screen showing a relation between the changed first document element and one or more second document elements associated with the first document element, each of the one or more second document elements is displayed in a display mode corresponding to the type of the relation between the second document element and the first document element.

20. A non-transitory computer readable medium storing a program causing a computer to perform:
performing difference extraction processing of extracting a difference between two versions of each of a first document element and a second document element; and
performing determination processing of determining a relation between the first document element and the second document element based on a similarity between the difference for the first document element and the difference for the second document element.
